(19) United States
(12) Patent Application Publication
(10) Pub. No.: US 2018/0349522 A1
(43) Pub. Date: Dec. 6, 2018

(54) Adaptive Modeling of Buildings During Construction

(71) Applicant: SITEAWARE SYSTEMS LTD., Tel Aviv (IL)

(72) Inventors: Ori Aphek, Ramat Gan (IL); Guy Raz, Binyamina (IL)

(21) Appl. No.: 15/997,709

(22) Filed: Jun. 5, 2018

Related U.S. Application Data
(60) Provisional application No. 62/514,977, filed on Jun. 5, 2017.
(60) Provisional application No. 62/514,982, filed on Jun. 5, 2017.

(51) Int. Cl. G06F 17/50

(52) U.S. Cl. CPC G06F 17/5004

(57) ABSTRACT

A method includes, using a processor, obtaining a digital building information model (BIM) that models a building plan for a building by virtue of defining a plurality of BIM objects associated with respective planned portions of the building, each BIM object having location information that indicates a respective location of the planned portion of the building associated with the BIM object, obtaining a reconstructed three dimensional model (RTDM) of the building that was reconstructed from information acquired by one or more optical sensors, using the location information of one or more of the BIM objects, identifying a correspondence between a portion of the RTDM and at least one of the BIM objects, by registering the RTDM and the BIM to one another, and modifying the portion of the RTDM, based on the corresponding BIM object. Other embodiments are also described.

### CROSS-REFERENCE TO RELATED APPLICATIONS

The present application claims the benefit of U.S. Provisional Application Nos. 62/514,977 and 62/514,982, each of which was filed on Jun. 5, 2017 and is incorporated herein by reference.

### FIELD OF THE INVENTION

The present invention is related to systems, methods, and computer program products for monitoring construction processes.

### BACKGROUND

U.S. Pat. No. 9,424,371 entitled “Click to accept as built modeling” discusses a method, system, apparatus, and computer program product for augmenting an as-built model. A CAD drawing of a project as well as a digital representation of a physical implementation of the project are obtained. A relationship that maps the digital representation to the CAD drawing is defined/established. A component of the digital representation is identified based on the relationship (e.g., and a database/catalog). Information about the identified component is transmitted to and displayed on a computer (e.g., a mobile device).

U.S. Pat. No. 9,508,186 entitled “Pre-segment point cloud model data to run real-time shape extraction faster” discloses a method, apparatus, system, and computer readable storage medium for enabling pre-segment point cloud model data. Point cloud model data is obtained and segmented. The segment information is stored. An indexing structure is created and instantiated with the point cloud model data and the segment information. Based on the segment information, a determination is made regarding points needed for shape extraction. Needed points are fetched from the indexing structure and used to extract shapes. The extracted shapes are used to cull points from the point cloud model data.

U.S. Pat. No. 8,942,483 entitled “Image-based georeferencing” discloses an image-based georeferencing system includes an image receiver, an image identification processor, a reference feature determiner, and a feature locator. The image receiver is configured for receiving a first image for use in georeferencing. The image includes digital image information. The system includes a communicative coupling to a georeferenced images database of images. The image identification processor is configured for identifying a second image from the georeferenced images database that correlates to the first image. The system includes a communicative coupling to a geographic location information system. The reference feature determiner is configured for determining a reference feature common to both the second image and the first image. The feature locator is configured for accessing the geographic information system to identify and obtain geographic location information related to the common reference feature.

U.S. Pat. No. 8,754,805 entitled “Method and apparatus for image-based positioning” discusses a method and apparatus for image based positioning including capturing a first image with an image capturing device, and the first image includes at least one object. Moving the platform and capturing a second image with the image capturing device. The second image including the at least one object. Capturing in the first image an image of a surface; capturing in the second image a second image of the surface. Processing the plurality of images of the object and the surface using a combined feature based process and surface tracking process to track the location of the surface. Finally, determining the location of the platform by processing the combined feature based process and surface based process.

U.S. Patent Application Publication 2013/0155058 describes a method for monitoring construction progress, which may include storing in memory multiple unordered images obtained from photographs taken at a site; melding the multiple images to reconstruct a dense three-dimensional (3D) as-built point cloud model including merged pixels from the multiple images in 3D space of the site; rectifying and transforming the 3D as-built model to a site coordinate system existing within a 3D as-planned building information model (“as-planned model”); and overlaying the 3D as-built model with the 3D as-planned model for joint visualization thereof to display progress towards completion of a structure shown in the 3D as-planned model. The processor may further link a project schedule to the 3D as-planned model to generate a 4D chronological as-planned model that, when visualized with the 3D as-built point cloud, provides clash detection and schedule quality control during construction.

U.S. Patent Application Publication 2015/0310135 describes a system and method for, using structure-from-motion techniques, projecting a building information model (BIM) into images from photographs taken of a construction site to generate a 3D point cloud model using the BIM. The method, when combined with scheduling constraints, facilitates 4D visualizations and progress monitoring. One of the images acts as an anchor image. Indications are received of first points in the anchor image that correspond to second points in the BIM. Calibration information for an anchor camera is calculated based on the indications and on metadata extracted from the anchor image, to register the anchor image in relation to the BIM. A nomography transformation is determined between the images and the anchor camera using the calibration information, to register the rest of the images with the BIM, where some of those images are taken from different cameras and from different angles to the construction site.

### SUMMARY OF THE INVENTION

There is provided, in accordance with some embodiments of the present invention, a system that includes a memory and a processor. The processor is configured to obtain, from the memory, a first digital building information model (BIM) that models a building plan for a building by virtue of defining a plurality of BIM objects associated with respective planned portions of the building, each BIM object having location information that indicates a respective location of the planned portion of the building that is associated with the BIM object. The processor is further configured to obtain a reconstructed three dimensional model (RTDM) of the building that was reconstructed from information acquired by one or more optical sensors. The processor is further configured to, using the location information of one or more of the BIM objects, identify a correspondence between a portion of the RTDM and at least one of the BIM objects, by registering the RTDM and the first BIM to one another. The processor is further configured to identify a difference between the portion of the RTDM and the corresponding BIM object, and to generate a second digital BIM that models a current construction state of the building, by modifying the first BIM to account for the identified difference.

In some embodiments, the RTDM includes a point cloud model.

In some embodiments, the one or more optical sensors include one or more airborne optical sensors.

In some embodiments, the processor is configured to obtain the RTDM by generating the RTDM from the information acquired by the one or more optical sensors.

In some embodiments, the processor is configured to identify the difference by identifying geometrical relationships between the portion of the RTDM and the corresponding BIM object.

In some embodiments, the processor is configured to, in identifying the difference, identify an error in construction of the planned portion of the building that is associated with the corresponding BIM object.

In some embodiments, the processor is configured to modify the first BIM to account for the identified difference by adding at least one new BIM object to the first BIM.

In some embodiments, the processor is configured to modify the first BIM to account for the identified difference by removing at least one of the BIM objects from the first BIM.

In some embodiments, the processor is configured to modify the first BIM to account for the identified difference by adding color information, which is associated with the portion of the RTDM, to the first BIM.

There is further provided, in accordance with some embodiments of the present invention, a system that includes a memory and a processor. The processor is configured to obtain, from the memory, a digital building information model (BIM) that models a building plan for a building by virtue of defining a plurality of BIM objects associated with respective planned portions of the building, each BIM object having location information that indicates a respective location of the planned portion of the building associated with the BIM object. The processor is further configured to obtain a reconstructed three dimensional model (RTDM) of the building that was reconstructed from information acquired by one or more optical sensors. The processor is further configured to, using the location information of one or more of the BIM objects, identify a correspondence between a portion of the RTDM and at least one of the BIM objects, by registering the RTDM and the BIM to one another, and to modify the portion of the RTDM, based on the corresponding BIM object.

In some embodiments, the processor is configured to modify the portion of the RTDM by assigning, to the portion of the RTDM, metadata associated with the corresponding BIM object.

In some embodiments, the processor is further configured to display the portion of the RTDM in association with the assigned metadata.

In some embodiments, the metadata include a type of the planned portion of the building that is associated with the corresponding BIM object.

In some embodiments, the processor is further configured to control an operation of at least one of the optical sensors, based on the metadata.

In some embodiments, the processor is configured to modify the portion of the RTDM by correcting a location of an object belonging to the portion of the RTDM.

There is further provided, in accordance with some embodiments of the present invention, a method that includes, using a processor, obtaining a first digital building information model (BIM) that models a building plan for a building by virtue of defining a plurality of BIM objects associated with respective planned portions of the building, each BIM object having location information that indicates a respective location of the planned portion of the building that is associated with the BIM object. The method further includes obtaining a reconstructed three dimensional model (RTDM) of the building that was reconstructed from information acquired by one or more optical sensors. The method further includes, using the location information of one or more of the BIM objects, identifying a correspondence between a portion of the RTDM and at least one of the BIM objects, by registering the RTDM and the first BIM to one another. The method further includes identifying a difference between the portion of the RTDM and the corresponding BIM object, and generating a second digital BIM that models a current construction state of the building, by modifying the first BIM to account for the identified difference.

There is further provided, in accordance with some embodiments of the present invention, a method that includes, using a processor, obtaining a digital building information model (BIM) that models a building plan for a building by virtue of defining a plurality of BIM objects associated with respective planned portions of the building, each BIM object having location information that indicates a respective location of the planned portion of the building associated with the BIM object. The method further includes obtaining a reconstructed three dimensional model (RTDM) of the building that was reconstructed from information acquired by one or more optical sensors. The method further includes, using the location information of one or more of the BIM objects, identifying a correspondence between a portion of the RTDM and at least one of the BIM objects, by registering the RTDM and the BIM to one another, and modifying the portion of the RTDM, based on the corresponding BIM object.

According to an aspect of the invention, there is disclosed a computer-implemented method for analyzing building information models (BIMs) based on sensor-based reconstructed three dimensional models (RTDMs) of buildings, the method including executing on a processor the steps of:
a. Obtaining a BIM of a building, the BIM defining a plurality of multidimensional BIM objects associated with parts of the building, each BIM object having location information;
b. Obtaining a RTDM of the building which includes a plurality of RTDM objects, each having location information. The RTDM is reconstructed from information acquired by one or more optical sensors;
c. Aligning the RTDM and the BIM, thereby determining alignment information;
d. Matching to a selected BIM object at least one RTDM object, based on: (a) the alignment information, (b) the location information of the selected BIM object and (c) the location information of the at least one RTDM object; and
e. Determining supplementary information for the selected BIM object based on information of the at least one RTDM object matched to the selected BIM object.

According to a further aspect of the invention, the RTDM is a point cloud model.

According to a further aspect of the invention, the one or more optical sensors are one or more airborne optical sensors.

According to a further aspect of the invention, the one or more optical sensor includes one or more cameras which produce a plurality of images of the building captured at different camera locations.

According to a further aspect of the invention, the method further includes generating the RTDM based on the information acquired by one or more optical sensors.

According to a further aspect of the invention, the method further includes calculating distances between a RTDM object and BIM objects based on the alignment information, and matching for each RTDM object out of a plurality of RTDM objects a closest BIM object having a minimal distance to the respective RTDM object.

According to a further aspect of the invention, the supplementary information includes a construction state for a part of the building associated in the BIM with the selected BIM object.

According to a further aspect of the invention, the method further includes obtaining a construction timing schedule for the part of the building, and determining a completion state for at least one predefined construction task based on a result of a comparison between the constructing timing schedule and the determined construction state.

According to a further aspect of the invention, the method further includes determining a construction state for a part of the building based on at least two RTDMs generated from optical sensor information acquired at different days.

According to a further aspect of the invention, the method further includes determining geometrical relationships between the selected BIM object and matching RTDM objects, and determining errors in the construction of a part of the building associated in the BIM with the selected BIM object.

According to a further aspect of the invention, the method further includes modifying preexisting BIM information based on results of the matching.

According to a further aspect of the invention, the method further includes generating new objects in the BIM based on the supplementary information.

According to a further aspect of the invention, the method further includes superimposing at least a part of the RTDM and at least a part of the BIM based on a result of the matching, and obtaining a user input for a result of the superimposition. The supplementary information in this case is further based on the user input.

According to a further aspect of the invention, the supplementary information includes color information associated by the RTDM with a RTDM object matched to the selected BIM object.

According to an aspect of the invention, there is disclosed a system for analyzing building information models (BIMs) based on sensor-based reconstructed three dimensional models (RTDMs) of buildings, including:
a tangible memory unit, operable to store: (i) a BIM of a building, which defines a plurality of multidimensional BIM objects associated with parts of the building, each BIM object having location information; and (ii) a RTDM of the building which includes a plurality of RTDM objects, each having location information (the RTDM is reconstructed from information acquired by one or more optical sensors); and
a processor, connected to the tangible memory unit and configured to: (i) align the RTDM and the BIM, thereby determining alignment information; (ii) match to a selected BIM object at least one RTDM object, based on: (a) the alignment information, (b) the location information of the selected BIM object and (c) the location information of the at least one RTDM object; and (iii) determine supplementary information for the selected BIM object, based on information of the at least one RTDM object matched to the selected BIM object.

According to a further aspect of the invention, the RTDM is a point cloud model.

According to a further aspect of the invention, the one or more optical sensors are one or more airborne optical sensors.

According to a further aspect of the invention, the one or more optical sensor include one or more cameras which produce a plurality of images of the building captured at different camera locations.

According to a further aspect of the invention, the system includes a photogrammetry processing module configured to generate the RTDM based on the information acquired by one or more optical sensors.

According to a further aspect of the invention, the processor is configured to calculate distances between a RTDM object and BIM objects based on the alignment information, and to match for each RTDM object out of a plurality of RTDM objects a closest BIM object having a minimal distance to the respective RTDM object.

According to a further aspect of the invention, the supplementary information includes a construction state for a part of the building associated in the BIM with the selected BIM object.

According to a further aspect of the invention, the system includes a construction management module which is configured to: obtain a construction timing schedule for the part of the building, and to determine a completion state for at least one predefined construction task based on a result of a comparison between the constructing timing schedule and the determined construction state.

According to a further aspect of the invention, the system includes a construction management module which is configured to determine a construction state for a part of the building based on at least two RTDMs generated from optical sensor information acquired at different days.

According to a further aspect of the invention, the processor is further configured to: (i) determine geometrical relationships between the selected BIM object and matching RTDM objects, and (ii) determine errors in the construction of a part of the building associated in the BIM with the selected BIM object.

According to a further aspect of the invention, the processor is further configured to modify preexisting BIM information stored in the tangible memory unit, based on results of the matching.

According to a further aspect of the invention, the processor is configured to generate new objects in the BIM based on the supplementary information, and to write the new objects to the BIM stored in the tangible memory unit.

According to a further aspect of the invention, the processor is further configured to: (i) superimpose at least a part of the RTDM and at least a part of the BIM, based on a result of the matching; (ii) obtain a user input for a result of the superimposition, and (iii) to determine at least a part of the supplementary information based on the user input.

According to a further aspect of the invention, the supplementary information includes color information associated by the RTDM with a RTDM object matched to the selected BIM object.

According to an aspect of the invention, there is disclosed a non-transitory computer-readable medium for analyzing building information models (BIMs) based on sensor-based reconstructed three dimensional models (RTDMs) of buildings, including instructions stored thereon, that when executed on a processor, perform the steps of:
a. Obtaining a BIM of a building, the BIM defining a plurality of multidimensional BIM objects associated with parts of the building, each BIM object having location information;
b. Obtaining a RTDM of the building which includes a plurality of RTDM objects, each having location information (the RTDM is reconstructed from information acquired by one or more optical sensors);
c. Aligning the RTDM and the BIM, thereby determining alignment information;
d. Matching to a selected BIM object at least one RTDM object, based on: (a) the alignment information, (b) the location information of the selected BIM object and (c) the location information of the at least one RTDM object; and
e. Determining supplementary information for the selected BIM object based on information of the at least one RTDM object matched to the selected BIM object.

According to a further aspect of the invention, the RTDM is a point cloud model.

According to a further aspect of the invention, the one or more optical sensors are one or more airborne optical sensors.

According to a further aspect of the invention, the one or more optical sensor includes one or more cameras which produce a plurality of images of the building captured at different camera locations.

According to a further aspect of the invention, the non-transitory computer-readable medium further includes instructions stored thereon, that when executed on a processor, perform: generating the RTDM based on the information acquired by one or more optical sensors.

According to a further aspect of the invention, the non-transitory computer-readable medium further includes instructions stored thereon, that when executed on a processor, perform: calculating distances between a RTDM object and BIM objects based on the alignment information, and matching for each RTDM object out of a plurality of RTDM objects a closest BIM object having a minimal distance to the respective RTDM object.

According to a further aspect of the invention, the supplementary information includes a construction state for a part of the building associated in the BIM with the selected BIM object.

According to a further aspect of the invention, the non-transitory computer-readable medium further includes instructions stored thereon, that when executed on a processor, perform: obtaining a construction timing schedule for the part of the building, and determining a completion state for at least one predefined construction task based on a result of a comparison between the constructing timing schedule and the determined construction state.

According to a further aspect of the invention, the non-transitory computer-readable medium further includes stored thereon, that when executed on a processor, perform: determining a construction state for a part of the building based on at least two RTDMs generated from optical sensor information acquired at different days.

According to a further aspect of the invention, the non-transitory computer-readable medium further includes instructions stored thereon, that when executed on a processor, perform: determining geometrical relationships between the selected BIM object and matching RTDM objects, and determining errors in the construction of a part of the building associated in the BIM with the selected BIM object.

According to a further aspect of the invention, the non-transitory computer-readable medium further includes instructions stored thereon, that when executed on a processor, perform: modifying preexisting BIM information based on results of the matching.

According to a further aspect of the invention, the non-transitory computer-readable medium further includes instructions stored thereon, that when executed on a processor, perform: generating new objects in the BIM based on the supplementary information.

According to a further aspect of the invention, the non-transitory computer-readable medium further includes instructions stored thereon, that when executed on a processor, perform: superimposing at least a part of the RTDM and at least a part of the BIM based on a result of the matching, and obtaining a user input for a result of the superimposition; where the supplementary information is further based on the user input.

According to a further aspect of the invention, the supplementary information includes color information associated by the RTDM with a RTDM object matched to the selected BIM object.

The present invention will be more fully understood from the following detailed description of embodiments thereof, taken together with the drawings, in which:

### BRIEF DESCRIPTION OF THE DRAWINGS

FIGS. 1A and 1B illustrate acquisition of images of a building by an optical imaging sensor, in accordance with examples of the presently disclosed subject matter;

FIG. 2 is a flow chart illustrating an example of a computer-implemented method for model assisted building, in accordance with the presently disclosed subject matter;

FIG. 3 is a flow chart illustrating optional implementations of the alignment stage of FIG. 2, in accordance with the presently disclosed subject matter;

FIG. 4 is a flow chart illustrating optional implementations of the matching stage of FIG. 2, in accordance with the presently disclosed subject matter;

FIG. 5 is a flow chart illustrating an example of a computer-implemented method for analyzing building information models based on sensor-based reconstructed three dimensional models of buildings, in accordance with the presently disclosed subject matter;

FIGS. 6 and 7 illustrate optional sub-stages of a stage of the method of FIG. 5, in accordance with examples of the presently disclosed subject matter;

FIG. 8 is a flow chart illustrating an example of a computer-implemented method for analyzing building information models based on sensor-based reconstructed three dimensional models of buildings, in accordance with the presently disclosed subject matter;

FIGS. 9, 10, 11, and 12 are flow charts illustrating examples of computer-implemented methods for improved reconstructed three dimensional models of buildings based on building information models, in accordance with the presently disclosed subject matter;

FIGS. 13A through 13E are diagrams illustrating matching of reconstructed three dimensional model objects and multidimensional building information model objects, in accordance with examples of the presently disclosed subject matter;

FIG. 14 illustrates an environment in which any the methods of the previous drawings could be executed and utilized, as well as a system, in accordance with the presently disclosed subject matter;

FIG. 15 is a functional block diagram illustrating an example of a system for model assisted building, in accordance with the presently disclosed subject matter; and

FIG. 16 illustrates additional optional components of the system of FIG. 15, in accordance with examples of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In order to understand the invention and to see how it may be carried out in practice, embodiments will now be described, by way of non-limiting examples only, with reference to the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, or the like, include action and/or processes of a computer that manipulate and/or transform data into other data, said data represented as physical quantities, e.g. such as electronic quantities, and/or said data representing the physical objects.

The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

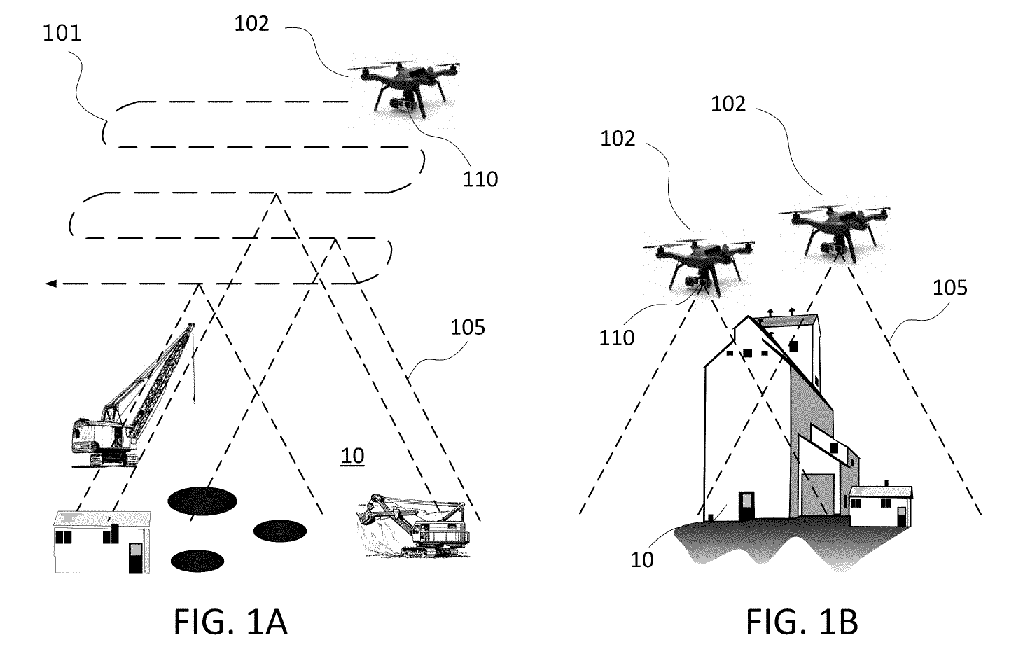

FIGS. 1A and 1B illustrate acquisition of images of a building 10 by an optical imaging sensor 110, in accordance with examples of the presently disclosed subject matter. Aircraft 102 carries an optical sensor 110 (interchangeably “sensor 110”) which is used for acquisition of the images of the building 10.

The images can be acquired by a single sensor 110 (e.g. as illustrated in FIG. 1A, where the sensor 110 is carried by an aircraft 102 which flies in path 101 over and/or around building 10) or by a plurality of sensors 110 (e.g. as illustrated in FIG. 1B). The images of building 10 may be acquired simultaneously or at different times (whether over the span of seconds, minutes, or even weeks or months). The acquisition of each image is represented in the drawings by the field of view (FOV) 105 of the respective sensor 110 during the acquisition of the respective image. The images may be acquired from preselected points of view of sensor 110, but this is not necessarily so.

Optionally, geolocation information is stored with each image, indicative of a location and direction of the sensor 110 at the time of acquisition. Other parameters (e.g. aircraft parameters such as speed vector, roll, pitch and yaw speeds, etc., camera parameters such as f-number, etc., and so on) may also be stored with any one or more of the images.

The term “building” as used herein refers to manmade structures which are sufficiently large to host groups of people inside them, for various uses (e.g. residence buildings, factories, silos, museums, banks, the statue of liberty, etc.). The term building as used in the present disclosure can pertain to different stages of the building—from the construction site (e.g. as exemplified in FIG. 1A), to the semi complete building, to the operational building (e.g. as exemplified in FIG. 1B), and possibly to the demolishing stages of the building, where applicable.

In the present example, sensor 110 is carried by an aircraft, and is therefore an airborne sensor. It is noted that other types of sensors may also be used (e.g. ground sensor, railed sensor, marine sensor), or combinations of sensors (e.g. some images acquired by a ground sensor, while others are acquired by an airborne sensor).

The term “optical sensor” is widely used in the art, and should be construed in a non-limiting way to include any suitable type of optical sensor, such as an optical camera (capturing visible light, infrared light and/or ultraviolet light), a LIDAR, or a combination of both.

Optical sensor 110 may optionally be carried by a mobile platform of any kind (e.g. aircraft, crane, car), whether manned or unmanned, remotely controlled or autonomous. Different types of aircrafts may be used, such as a drone, an airplane, a helicopter, a multirotor helicopter (e.g. a quadcopter), any other type of unmanned aerial vehicle (UAV), or a motorized parachute. The type of aircraft 102 (or other carrying platform of sensor 110) may be determined based on various considerations, such as aerodynamic parameters (e.g. velocity, flight altitude, maneuvering capabilities, stability, carrying capabilities, etc.), degree of manual control or automation, additional uses required from the aircraft, and so on. Optionally, imaging sensor 110 may be otherwise moved between different positions. For example, sensor 110 may be installed on a crane, and may thus capture vertical (i.e. downward-looking) or diagonal images from different positions, alternatively (or in addition) to an aircraft carried airborne sensor.

The distance of sensor 110 from building 10 during acquisition of the images may change, depending for example on image resolution, field of view, required overlap between images, local flight regulations, safety considerations and so on. For example, a distance of sensor 110 from building 10 during acquisition of the images may be between 3 and 150 meters.

Geolocation is the identification or estimation of the real-world geographic location of an object (e.g. a building, a window, a bulldozer, a mobile phone, etc.) or of an otherwise identifiable location (e.g. terrain formation, colored spot on a surface, etc.). Geolocation may include generation, storing and/or processing of a set of geographic coordinates (e.g. World Geodetic System coordinates, European Terrestrial Reference System coordinates, etc.), or additional data such as street address, etc. The accuracy of geolocation information for images or points in the context of the present invention may vary. For example, the accuracy (and respectively location error) of any point, image anchor etc. may be 1 to 10 cm.

The term “geolocated image” as used herein pertains to an image that is associated with geolocation information (e.g. indicative of the geolocation of the center of the image, its corner, or any other point in the image). The term “geolocated point” as used herein pertains to a point of a point cloud model (PCM) that is associated with geolocation information (e.g. indicative of the geolocation of the point). It is noted that a PCM point is not necessarily a geolocated point.

The term “geolocated object,” and similar terms (e.g. “geolocated BIM object”, “geolocated RTDM object”, etc.) used herein, pertain to an object of a model of the building (e.g. CAD, BIM, RTDM) that is associated with geolocation information (e.g. indicative of the geolocation of the object). It is noted that an object of such a model is not necessarily geolocated. A PCM point is a particular case of a model object, which may be geolocated in some types of point cloud models, but not necessarily so. It is noted that in different implementations of the present invention, any one or more of the models used may be geolocated, or none of the models may be geolocated.

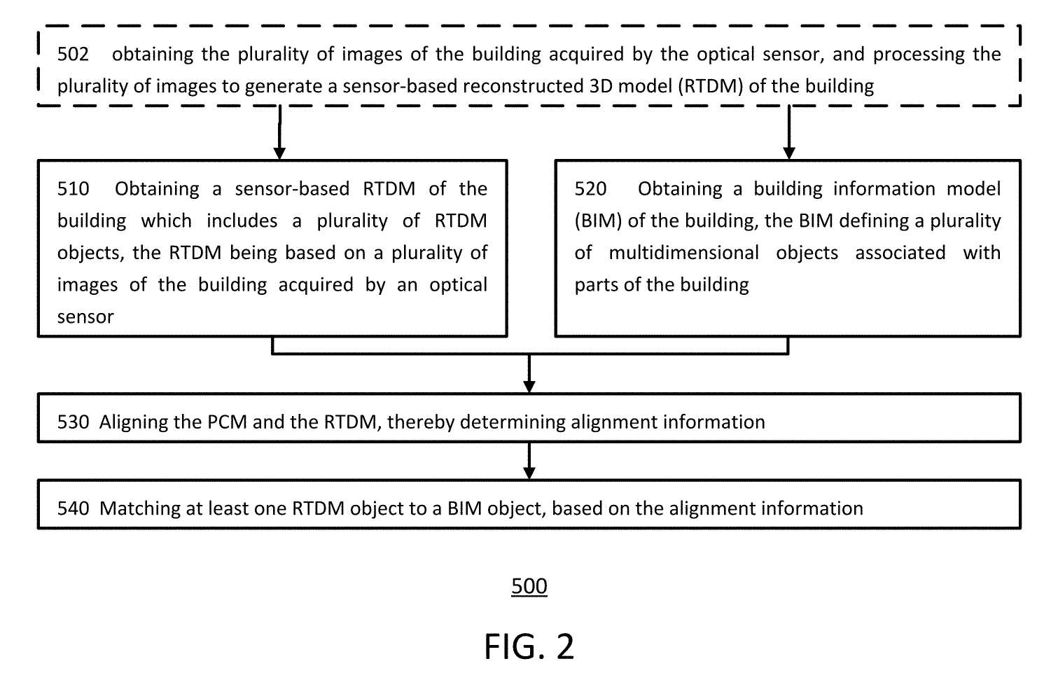

FIG. 2 is a flow chart illustrating an example of method 500, in accordance with the presently disclosed subject matter. Method 500 is a computer-implemented method for model assisted building, which includes executing, on a processor, different steps, including at least stages 510, 520, 530 and 540. Referring to the examples set forth with respect to the following drawings, method 500 may be executed by system 200.

Stage 510 of method 500 includes obtaining a sensor-based reconstructed three dimensional model (RTDM) of the building, the RTDM model including a plurality of RTDM objects. The RTDM obtained in stage 510 (and later used in following stages of method 500) is sensor-based in the sense that it is reconstructed from information acquired by one or more sensors. Specifically, the sensor-based RTDM obtained in stage 510 is reconstructed from a plurality of images of the building acquired by an optical sensor, e.g. as discussed with respect to FIGS. 1A and 1B. As noted above, the plurality of images of the building may be acquired by one or more optical sensors, and at one or more times. As noted above, the sensor may be an airborne sensor, but this is not necessarily so.

The terms “reconstruction” is widely accepted in the art, and should be construed to include the creation of three-dimensional (3D) models from a set of images. The created models may include four dimensions, e.g. if time is also determined using images taken at different times.

Different types of RTDM may be obtained and used within the scope of the present invention. Types of RTDM which may be used include (but are not limited to):
a. Point Cloud Model (PCM).
b. Polygon Mesh (e.g. a triangle mesh).
c. OBJ file.

Some details regarding each of these model types are provided below, before the discussion of method 500 continues.

The terms “point cloud” and “point cloud model” are widely accepted in the art, and should be construed to include a set of data points located spatially in some coordinate system (i.e. having an identifiable location in a space described by the respective coordinate system). The term “PCM point” refers to a point in space (which may be dimensionless, or a miniature cellular space, e.g. 1 cm3), whose location is described by the PCM using a set of coordinates (e.g. X,Y,Z). The PCM may store additional information for some or all of its points (e.g. color information for PCM points generated from camera images), but this is not necessarily so. Likewise, any other type of RTDM may store additional information for some or all of its RTDM objects (e.g. color information for RTDM objects generated from camera images), but this is not necessarily so.

The terms “polygon mesh” and “triangle mesh” are widely accepted in the art, and should be construed to include a set of vertices, edges and faces that defines the shape of one or more 3D objects (especially a polyhedral object). The faces may include any one or more of the following: triangles (triangle mesh), quadrilaterals, or other simple convex polygons, since this simplifies rendering. The faces may also include more general concave polygons, or polygons with holes. Polygon meshes may be represented in different techniques, such as: Vertex-vertex meshes, Face-vertex meshes, Winged-edge meshes and Render dynamic meshes. Different objects of the polygon mesh (e.g. vertex, face, edge) are located spatially in some coordinate system (i.e. having an identifiable location in a space described by the respective coordinate system), either directly and/or relatively to one another.

OBJ (or .OBJ) is a file standard for representing multidimensional geometry using 3D geometry and textures. The standard was developed by Wavefront Technologies and later adopted by other 3D graphics application vendors.

In many variations of RTDMs (whether PCM, polygon meshes, or other), the space in which object locations, positions and/or orientations are identified is a 3D space. Nevertheless, spaces of other dimensions may also be used. In a three-dimensional coordinate system, the locations of the RTDM objects may be defined using X, Y, and Z coordinates, or in any other way. The coordinates system applied by the RTDM may be tied to an external coordinate system (e.g. geographic coordinates such as WGS and ETRS described above), but this is not necessarily so. The coordinates system used by the RTDM may use a known distance measure (e.g. 1 centimeter, 1 inch), but this is not necessarily so, and the distance dimensions in the RTDM may be relative and/or arbitrary.

While not necessarily so, RTDMs are often are intended to represent the external surface of an object (e.g. a building). Nevertheless, the RTDM may also include RTDM objects corresponding to interior parts of the building (e.g. interior building parts seen by the sensor through openings in the envelope of the building, such as windows, patios and unfinished roofs). The number of points, vertexes, faces, edges etc. in the RTDM may vary greatly, depending on the specific application. In an example, the number of PCM points in the PCM may be between 1,000,000 and 1,000,000,000. In an example, the number of polygons in the polygon mesh may be between 100,000 and 100,000,000.

The generation of the RTDM may be implemented using any standard photogrammetry technique known in the art, or any novel technique. The generation of the RTDM of the building may be a part of method 500 (optional stage 502), but not necessarily so. Optional stage 502 includes obtaining the plurality of images of the building acquired by the optical sensor, and processing the plurality of images to generate the RTDM. Method 500 may also include the acquisition of the images used for the generation of the RTDM (not illustrated in FIG. 2) by the optical sensor.

It is noted that a polygon mesh, if used in method 500 as the RTDM, may be generated from a point cloud model (which in turn may be generated from processing of the image sensor). However, this is not necessarily so, and a polygon mesh, if used in method 500 as the RTDM, may also be generated directly from processing of the images.

In the former case, the PCM may be turned into a polygon mesh (e.g. a triangle mesh) by applying smoothing algorithms, then determining which points to lose, and then closing polygons from neighboring points. The texture for each polygon is not necessarily uniform, and may be a color value or an image layer determined from one or more of the original pictures. Therefore, a polygon mesh may contain more visual information than the point cloud.

The generation of a polygon mesh directly from the original image may be done by triangulation of objects or features appearing in two or more images (those features may optionally be marked manually).

It is noted that the RTDM may also include information pertaining to the area of the building—e.g. adjacent buildings and/or vehicles, plantations, construction site objects, adjacent roads, etc.

Referring to the elements set forth with respect to the following drawings, stage 510 may be executed by memory 210, processor 220 and/or communication module 290. Referring to the elements set forth with respect to the following drawings, optional stage 502 may be executed by processor 220 and/or photogrammetry processing module 230.

Stage 520 of method 500 includes obtaining a building information model (BIM) of the building, the BIM defining a plurality of multidimensional objects associated with parts of the building. Referring to the elements set forth with respect to the following drawings, stage 520 may be executed by memory 210, processor 220 and/or communication module 290.

The term Building Information Model (BIM) is widely accepted in the art, and should be construed to include a digital representation of physical and functional characteristics of a facility, such as a building. A BIM may be used as a shared knowledge resource for information about a facility forming a reliable basis for decisions during its life-cycle (from earliest conception to demolition). Many BIM formats are known in the art, such as the ones implemented by Autodesk Revit™ and ARCHICAD™.

Typically, a BIM includes an “as planned” model of the building, and in some cases, multiple models which represent the planned building in different phases of the planned construction project. Each model includes multidimensional digital objects, each of which represents a respective portion of the building, and is “multidimensional” by virtue of having multiple attributes. For example, each object may include location information, along with metadata assigned to the object, such as planned time to be built, material type, and the type of the portion of the building to which the object corresponds. (Examples of types of building portions include windows, walls, foundations, and scaffolding.) Typically, the location information explicitly or implicitly defines one or more points, lines, and/or planes, which correspond, respectively, to points, edges, and/or surfaces of the portion of the building. A BIM may thus be registered with an RTDM, as described herein, by registering these points, lines, and/or planes with the points, lines, and/or planes of the RTDM.

The BIM is also based on at least one coordinate space, in which BIM objects are located. The coordinate space of the BIM may be three dimensional (e.g. using X,Y,Z coordinates) or other. The coordinate system used by the BIM may be tied to an external coordinate system, but this is not necessarily so. Usually the coordinates system used by the BIM utilizes a known distance measure (e.g. 1 centimeter), but this is not necessarily so.

Stages 510 and 520 may be executed concurrently, partly concurrently, or in nonoverlapping times.

Stage 530 of method 500 is executed after stages 510 and 520, and includes aligning the RTDM and the BIM, thereby determining alignment information, i.e., ascertaining the transformation that aligns the RTDM and the BIM with one another. Aligning (or registration of) two models is the process of transforming the data sets of the different models into one coordinate system. The target coordinate system may be the coordinate system of the BIM, the coordinate system of the PCM, or any other coordinate system.

Many algorithms for alignment of models (especially 3D models) are known in the art, and stage 530 may involve implementing any one of these algorithms, and/or any other algorithms, depending on the requirements of the specific implementation. The alignment (alternately “registration”) performed during stage 530 may optionally be based on any combination of one or more of the following:
a. Location information of RTDM objects and/or BIM objects.
b. Features comparisons between the models.
c. Minimal distances between RTDM objects and BIM objects (e.g. using “iterative closest point” algorithm, ICP).
d. Other parameters.

The alignment information may be determined (i.e., ascertained) in different ways, many of which are known in the art. The alignment information allows transformation of RTDM location (e.g. RTDM coordinates) to BIM location (e.g. BIM coordinates) and vice versa. The alignment information determined in stage 530 may include, for example, information indicative of any combination of one or more of the following transformations:
a. Translations.
b. Rotations.
c. Scaling.
d. Skewing.

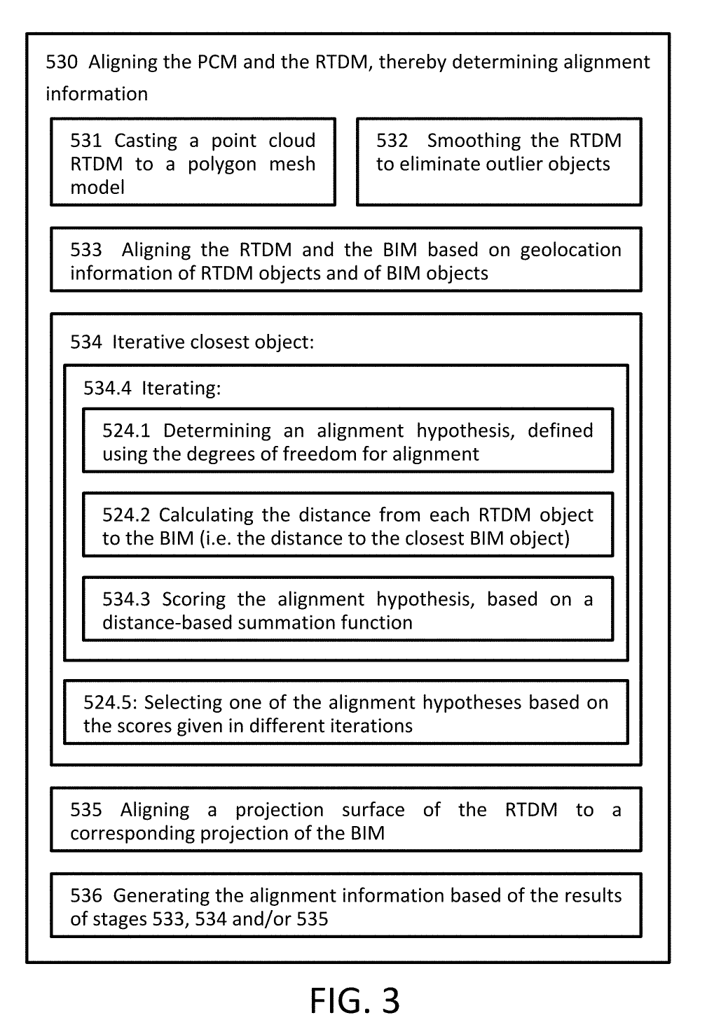

Additional information regarding the alignment is discussed with respect to FIG. 3.

Method 500 continues with stage 540 of matching at least one RTDM object to a BIM object, based on the alignment information determined in stage 530. Referring to the elements set forth with respect to the following drawings, stage 540 may be executed by processor 220.

In addition to the alignment information, the matching of stage 540 may also be based on:
a. Location information of the matched RTDM object (and possibly of other RTDM objects as well) derived from the RTDM, and
b. Location information of the matched BIM object (and possibly of other BIM objects as well) derived from the BIM.

The matching of BIM objects (e.g. walls, doors) and RTDM objects (e.g. PCM points, polygons) may be done in different ways, and maybe based directly on the locations of the different objects, or on distances between BIM objects and RTDM objects. The distances (whether using absolute or relative scale) may be computed using the alignment information.

The matching may include matching multiple RTDM objects (e.g. multiple PCM points, multiple polygons) to a single BIM object. The matching may include matching RTDM objects to different BIM objects. Usually, each RTDM object will be matched to a single BIM object (e.g. many PCM points or polygons may correspond to a single window of the building as represented by the BIM), but this is not necessarily so. In addition, the matching may leave one or more RTDM objects and/or one or more BIM object without a match in the other model.

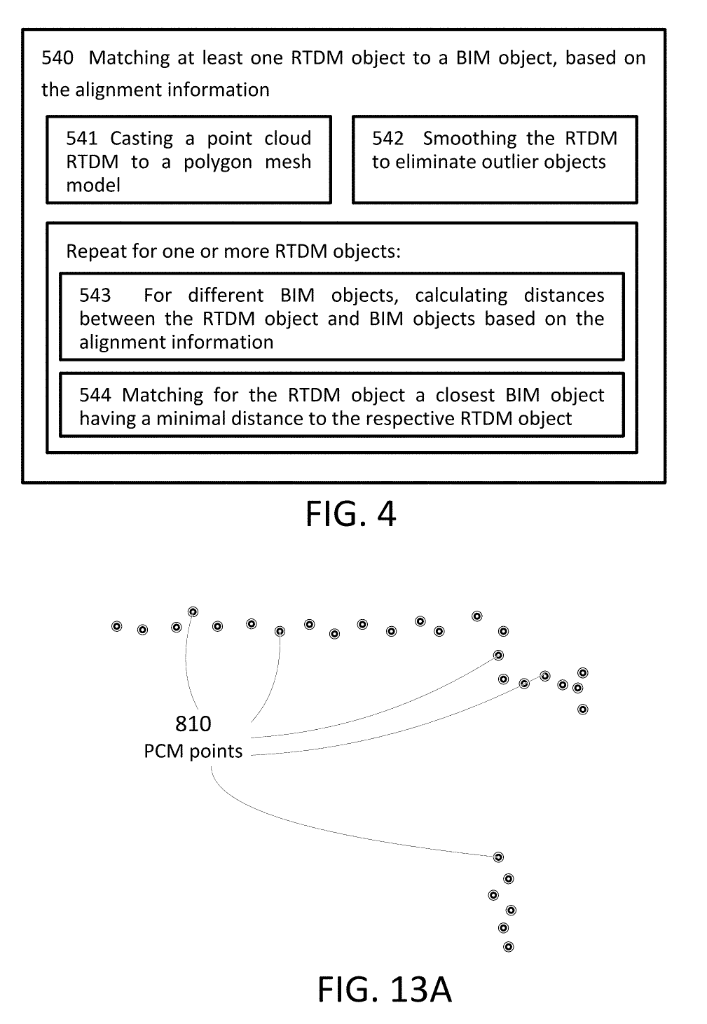

Additional information regarding to alignment is discussed with respect to FIG. 4.

FIG. 3 is a flow chart illustrating optional implementations of the alignment performed during stage 530, in accordance with the presently disclosed subject matter. Stage 530 may include preliminary stages for preparing the RTDM to alignment. For example, stage 530 may include stage 531 of casting (or otherwise converting) a point cloud RTDM (in case this type of RTDM is used) to a polygon mesh model, such that the following alignment stages are executed for a polygon mesh 3D model and the BIM. Optionally, stage 530 may include stage 532 of smoothing the RTDM to eliminate outliers (i.e. RTDM objects, such as PCM points, which are remote from other objects and are possibly the result of errors in the acquisition of the data).

The actual alignment between the RTDM and the BIM may be done in many ways, several of which are known in the art. A few examples of processes by which the RTDM and the BIM may be aligned are provided as stages 533, 534, and 535.

Stage 533 includes aligning the RTDM and the BIM based on geolocation information of RTDM objects and on geolocation information of BIM objects (also referred to as a “Drop-down” process).

Stage 534 includes applying iterative closest object (or “iterative closest point”, ICP, for a point cloud RTDM), which includes the following substages:

Stage 524.1: Determining an alignment hypothesis, defined using the relative global degrees of freedom for alignment (e.g. translation, rotation, scaling.)

Stage 524.2: Calculating the distance from each RTDM object (e.g. PCM point) to the BIM (distance is defined as the distance to the closest object), where the distances are calculated based on the alignment information and on the location information of the RTDM object and of the BIM objects.

Stage 534.3: scoring the alignment hypothesis, based on a distance-based summation function. The distance-based summation is usually designed to sum non-negative distances, e.g. by summing sum of squares of the distances, or their absolute values. The score assigned to the alignment hypothesis is an indication of the quality level of the fitting between the RTDM to the BIM in the given alignment hypothesis.

Stage 534.4: Reiterating stages 524.1, 524.2 and 534.3. It is noted that the determining of the alignment hypothesis for the following stages may optionally be based on the scores assigned to previous alignment hypotheses in previous iterations.

Stage 524.5: Selecting one of the alignment hypotheses based on the scores given in different iterations of stage 534.3. Now iterate on the relative global degrees of freedom to minimize the global distance measure. The degrees of freedom can include e.g. translation, rotation, scaling.

Optional stage 535 includes aligning a projection surface of the RTDM to a corresponding projection of the BIM (e.g. alignment of an orthographic view). For example, the aligning between projections may include generating a 2D model which is based on the BIM (e.g. which elements of the BIM are included and/or are visible in a horizontal slicing at a given height (e.g. 10 meters above ground), and finding a horizontal slicing of the RTDM which best matches the aforementioned BIM-based 2D model. Matching between several such projections or slices may be used to identify the best alignment between the models in one or more axes.

Stage 536 includes generating the alignment information based of the results of stages 533, 534 and/or 535.

FIG. 4 is a flow chart illustrating optional implementations of the matching of stage 540, in accordance with the presently disclosed subject matter. The matching may include preliminary stages for preparing the RTDM to alignment. For example, stage 540 may include a stage 541 of casting (or otherwise converting) a point cloud RTDM (in case this type of RTDM is used) to a polygon mesh model, where the following alignment stages are executed for a polygon mesh 3D model and the BIM. Optionally, stage 540 may include stage 542 of smoothing the RTDM to eliminate outliers (i.e. RTDM objects, such as PCM points, which are remote from other objects and are possibly the result of errors in the acquisition of the data). If any one of optional stages 531 and 532 is executed, the results of that stage may also be used in stage 540, if needed.

Stage 540 may implement the matching of an object of the BIM to an RTDM object by the following process:

Stage 543: for different BIM objects, calculating distances between the RTDM object and BIM objects (i.e. the distances between the aligned location of the RTDM object and the aligned location of the respective BIM objects) based on the alignment information (i.e., based on the transformation function that maps between the two coordinate spaces).

Stage 544: matching the RTDM object to a closest BIM object having a minimal distance to the RTDM object (so that a distance between the aligned locations of the RTDM object and the closest BIM object is smaller than any distance between that RTDM object and the location of any other BIM object of the BIM).

Optionally, stage 544 is executed only if the minimal distance determined in stage 543 is lower than a predefined maximal radius from the RTDM object, and if it is not so, no BIM object would be matched to the RTDM object.

The matching between BIM objects and RTDM objects, achieved in stage 540, may be followed by various computations for different needs in building monitoring and for other uses, e.g. as discussed below with respect to methods 600 and 700.

It is noted that method 500 may be implemented as instructions for a processor (e.g. a hardware and/or firmware processor of a computer), implemented on a non-transitory computer-readable medium. Any variation or implementation discussed above with respect to method 500 may also be implemented with respect to such a computer-readable medium, mutatis mutandis. Some examples to ways method 500 may be implemented using computer-readable code are provided below.

A non-transitory computer-readable medium is disclosed for model assisted building, including instructions stored thereon, that when executed on a processor, perform the steps of 500 (or any variation thereof), and at least stages 520, 530, 540 and 550.

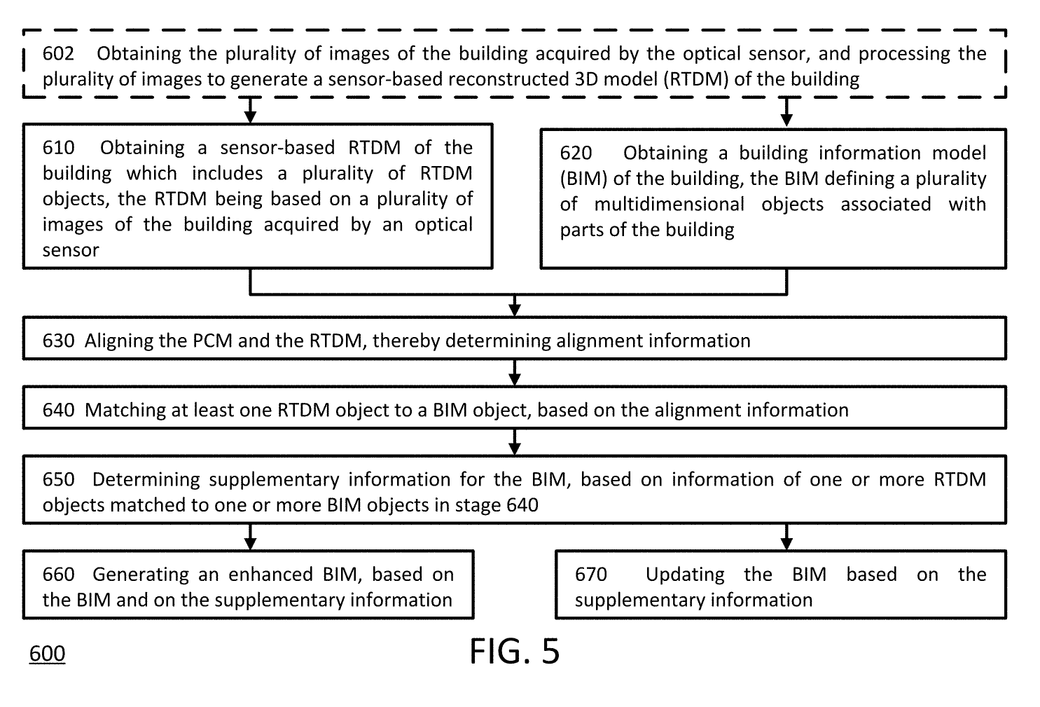

FIG. 5 is a flow chart illustrating an example of method 600, in accordance with the presently disclosed subject matter. Method 600 is a computer-implemented method for analyzing building information models (BIMs) based on sensor-based reconstructed three dimensional models (RTDMs) of buildings. Method 600 includes executing on a processor different steps, including at least stages 610, 620, 630, 640 and 650. Any other stage in the following description having a reference number starting with “6” (e.g. 650) may also be executed by the processor, or otherwise be part of method 600 (executed by a different unit). Referring to the examples set forth with respect to the following drawings, method 600 may be executed by system 200.

It is noted that method 600 may be implemented as a variation of method 500, and that the discussion above with any stage or sub-stage of method 500 (e.g. stages 510, 520, 530 and 540) may be applied, mutatis mutandis, to the respective stage of method 600 (e.g. stages 610, 620, 630 and 640, respectively)

Stage 610 includes obtaining an RTDM of the building which includes a plurality of RTDM objects, each having location information (the RTDM is reconstructed from information acquired by one or more optical sensors). Any information disclosed above with respect to stage 510 of method 500 is applicable, mutatis mutandis, to stage 610.

Stage 620 includes obtaining a BIM of a building, the BIM defining a plurality of multidimensional BIM objects associated with parts of the building, each BIM object having location information. Any information disclosed above with respect to stage 520 of method 500 is applicable, mutatis mutandis, to stage 620.

Stage 630 of method 600 includes aligning the RTDM and the BIM, thereby determining alignment information. Any information disclosed above with respect to stage 530 of method 500 is applicable, mutatis mutandis, to stage 630.

Stage 640 of method 600 includes matching to a selected BIM object at least one RTDM object, based on: (a) the alignment information, (b) the location information of the selected BIM object and (c) the location information of the at least one RTDM object. The matching may be further based on locations of other objects—whether BIM objects and/or RTDM objects. Any information disclosed above with respect to stage 540 of method 500 is applicable, mutatis mutandis, to stage 640. Stage 640 may be repeated for any number of BIM objects.

Stage 650 of method 600 includes determining supplementary information for the BIM, based on information of one or more RTDM objects matched to one or more BIM objects in stage 640. Stage 650 of method 600 includes at least determining supplementary information for the selected BIM object of a single instance of stage 640, based on information of the at least one RTDM object matched to that selected BIM object. Referring to the examples set forth with respect to the following drawings, stage 650 may be executed by processor 220 and/or BIM processing module 280.

Stage 650 may optionally be followed by optional stage 660 and/or by optional stage 670.

Optional stage 660 includes generating an enhanced BIM, based on the BIM obtained in stage 620 and on the supplementary information determined in stage 650. The generating of the enhanced BIM may include generating and storing on a tangible non-transitory computer readable medium at least one new computer file not existing previously, which includes enhanced BIM information which is based on the results of stage 650. Referring to the examples set forth with respect to the following drawings, stage 660 may be executed by processor 220 and/or BIM processing module 280.

Optional stage 670 includes updating the BIM obtained in stage 620 based on the supplementary information determined in stage 650. The updating of the BIM may include writing BIM information which is based on the results of stage 650 to at least one existing computer file which includes BIM information of the BIM of stage 620 and that is stored on a tangible non-transitory computer readable. Referring to the examples set forth with respect to the following drawings, stage 660 may be executed by processor 220 and/or BIM processing module 280.

Method 600 may include (e.g. as part of stages 660 and/or 670) modifying preexisting BIM information based on results of the matching. The modifying may include, for example, reflecting an actual construction state (based on sensor data) in the BIM, in places where it does not match the planned BIM. For example, processing of the RTDM data and the BIM data in stage 640 and/or 650 may reveal that a wall was built some 30 cm from its planned location, that a foundation shaft was drilled deeper (or shallower) than originally planned, and so on.

Method 600 may include (e.g. as part of stages 660 and/or 670) generating new BIM objects in the BIM, based on the supplementary information. This generation may also be used for reflecting an actual construction state (based on sensor data) in the BIM, in places where it does not match the planned BIM. For example, processing of the RTDM data and the BIM data in stage 640 and/or 650 may reveal locations of temporary objects such as scaffoldings, heavy machinery, etc., which may be used in further processing of the BIM, if included in it.

The supplementary information determined in stage 650 may include many types of information, such as (although not limited to):
a. Matching information for a BIM object, identifying one or more RTDM objects matched to that BIM object in stage 640.
b. Location of one or more RTDM objects matched to that BIM object in stage 640.
c. Color information associated with one or more RTDM objects matched to that BIM object in stage 640.
d. And so on.

Additional types of supplementary information are suggested below, with respect to the following drawings.

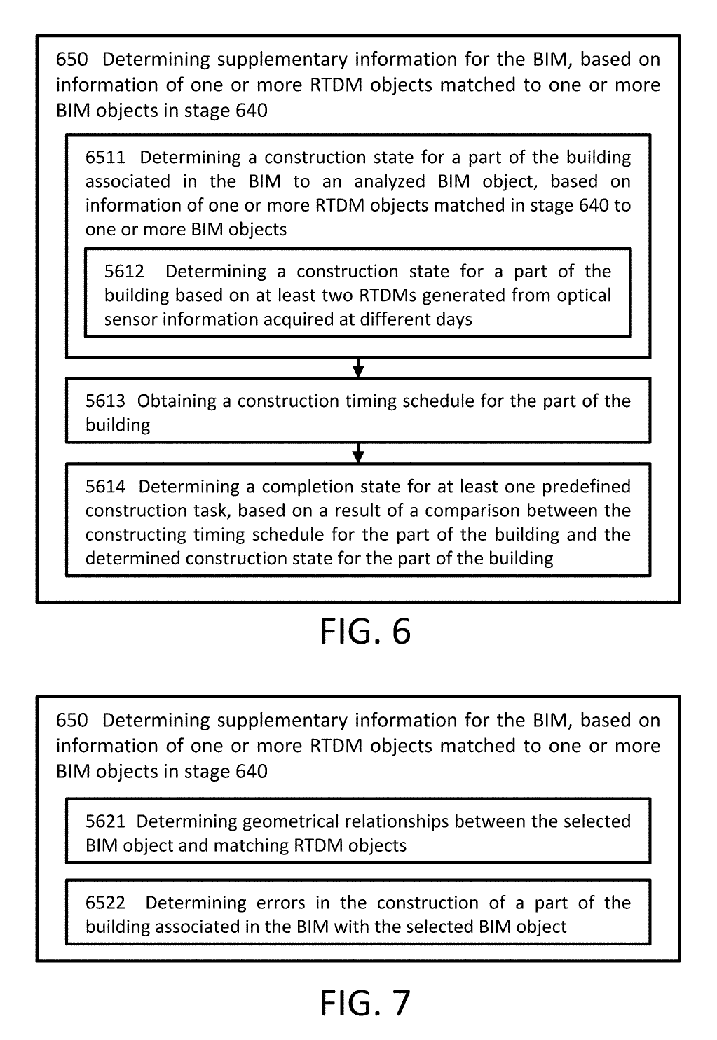

FIG. 6 illustrates optional sub-stages of stage 650, in accordance with examples of the presently disclosed subject matter. The supplementary information generated in the example of FIG. 6 may be used for following the progress of work on a building (e.g. construction, demolition). The stages of FIG. 6 may also be used, mutatis mutandis, to follow the changes of a building over time (e.g. renovation, deterioration, alternating uses, etc.).

Optionally, the supplementary information may include a construction state for a part of the building associated in the BIM with the selected BIM object. Stage 650 may include optional stage 6511 of determining a construction state for a part of the building associated in the BIM to an analyzed BIM object (one of the BIM objects for which a construction state is analyzed), based on information of one or more RTDM objects matched in stage 640 to one or more BIM objects (usually including the analyzed BIM object). Stage 6511 may be repeated for any number of analyzed BIM objects. Referring to the elements set forth with respect to the following drawings, stage 6511 may be executed by processor 220, by BIM processing module 280 and/or by construction management module 270.

It is noted that the construction state of the analyzed BIM object may optionally be determined in conditions when the matching of stage 640 did not yield any matched RTDM objects for the analyzed BIM object. For example, in response to not identifying an RTDM match, it may be ascertained that the building part associated with the analyzed BIM object was not yet built, was already demolished, or was translocated to an unidentifiable location, such as in the instance of a building part that fell into the interior of the building, and is thus not identifiable by an outside camera.

The term construction state refers to any characteristic of the condition of one or more of the objects represented in the BIM (e.g. window, door, wall, pole, etc.), such as:
a. Which part of the object was constructed? (e.g. during construction phase)
b. Which part of the object was destroyed? (e.g. during demolition phase)
c. Has the object deteriorated? How much? In which ways?
d. Was the object translocated or otherwise moved? In which direction?
e. Does the object interact (whether by touch, shading, or in any other ways) with other objects in the building? With external objects?

Stage 6511 may optionally include stage 5612 of determining a construction state for a part of the building based on at least two RTDMs generated from optical sensor information acquired at different times (e.g., on different days). This technique is useful, for example, in order to determine the construction state of building parts or features that are hidden in a later RTDM but are visible in a preceding RTDM, or vice versa.

Stage 6511 may optionally be followed by stage 5613 of obtaining a construction timing schedule for the part of the building (e.g. from the BIM or from another timing information plan), and by stage 5614 of determining a completion state for at least one predefined construction task based on a result of a comparison between the constructing timing schedule for the part of the building and the determined construction state for the part of the building. The construction task may be defined in a construction project schedule (which may include the construction timing schedule, in the BIM, or in any other format). Referring to the elements set forth with respect to the following drawings, stages 5613 and 5614 may be executed by processor 220, by BIM processing module 280 and/or by construction management module 270. The term “construction project schedule” (interchangeably “Construction Project workflow”) refers to planned tasks and timetable for the project. This building-related project may relate to any stage during the life cycle of the project, from the planning through construction, operational stage, renovation, and demolition or deterioration.

As aforementioned, the supplementary information may include color information associated in the RTDM with the RTDM object matched to the selected BIM object. This may be used, for example, in the determining of the construction state—e.g. for noting painting of walls, casting of shadows by some objects on other objects (even if the shadow casting objects are not viewed directly in the RTDM), etc.

FIG. 7 illustrates optional sub-stages of stage 650, in accordance with examples of the presently disclosed subject matter. The supplementary information generated in the example of FIG. 7 may be used for detecting errors in the construction of building, or in other phases of the building life (e.g. renovation, demolition). The supplementary information may also be used for the management and/or correction of such errors. Optionally, the supplementary information may include geometrical relationships between at least one BIM object and matching RTDM objects and/or errors in the construction associated with one or more BIM objects.

Stage 650 may optionally include stage 5621 of determining geometrical relationships between the selected BIM object and matching RTDM objects, and stage 6522 of determining errors in the construction of a part of the building associated in the BIM with the selected BIM object. It is noted that the RTDM is generated from sensor acquired data and is therefore representative of an actual state of the building in reality. The BIM, in comparison, is a planned construct (which may be based on measurement data), which is representative of an abstract state of the building, such as desired state (e.g. if the BIM is used for construction, renovation or demolition of the building). Referring to the elements set forth with respect to the following drawings, stages 5621 and/or 6522 may be executed by processor 220 and/or construction management module 270.

Examples of geometrical relationships which may be determined in stage 5621 between RTDM objects and BIM objects are:
a. Distances (measured in real world distance units, such as centimeters or inches);
b. Angles;
c. Geometrical transformations (e.g. affine transformation);
d. Distortions.

Examples of errors which may be detected in stage 6522 include:
a. Foundations for the building were dug in the wrong locations.
b. A wall which is supposed to be flat, as indicated in the BIM, is wavy in reality, as reflected in the RTDM.
c. Window sizes are too small (e.g., 5% too small) or too large.
d. A wall is not plumb.
e. A rail is not level.

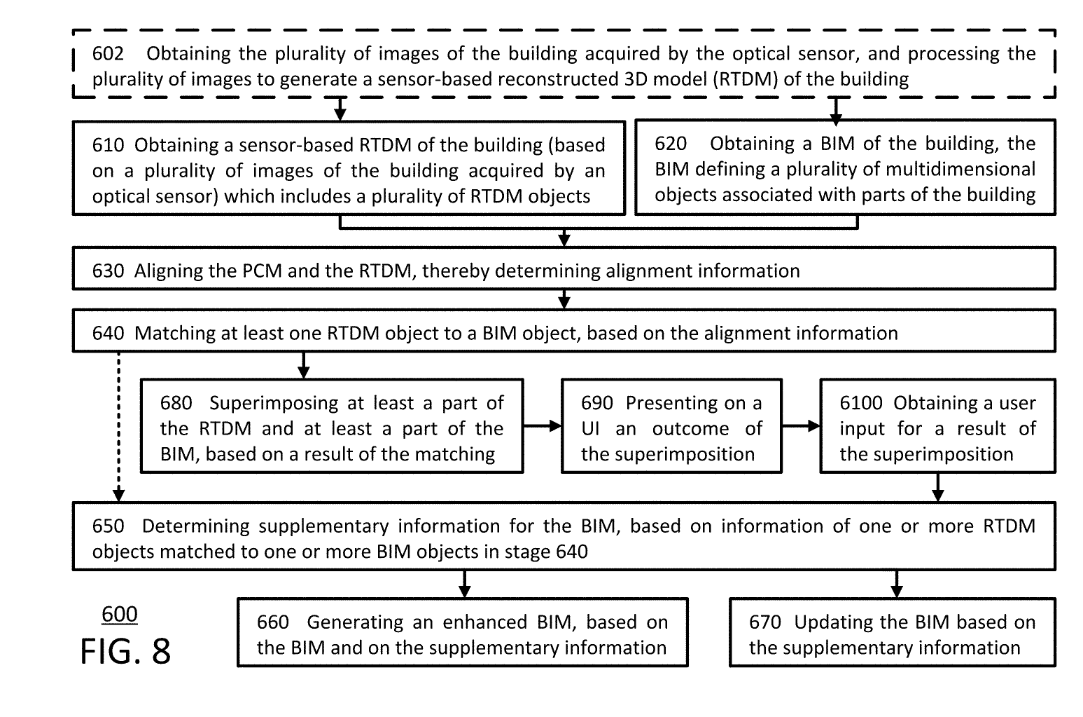

FIG. 8 is a flow chart illustrating an example of method 600, in accordance with the presently disclosed subject matter.

Optionally, method 600 may include stage 680 of superimposing at least a part of the RTDM onto at least a part of the BIM, based on a result of the matching. Referring to the elements set forth with respect to the following drawings, stage 680 may be executed by processor 220 or by any other processing module. Method 600 may also include stage 690 of presenting on a user interface (UI) an outcome of the superimposition, and stage 6100 of obtaining a user input for a result of the superimposition. The supplementary information in such a case may further be based on the user input. The user input may include manipulation by the user of BIM information (or her other reaction to BIM information), manipulation by the user of RTDM information (or her other reaction to RTDM information), manipulation by the user of combined BIM and RTDM information (or her other reaction to BIM and RTDM information), or any other input which pertains to the superimposed input (e.g. superimposed image, superimposed 3D representation, super imposed virtual reality data, and so on) presented to her.

Referring to the elements set forth with respect to the following drawings, it is noted that the UI may be a UI of system 200 (e.g. a monitor, projector, etc., not illustrated), but an external UI may also be used. The user input may be received via any user input interface known in the art (e.g. touchscreen, keyboard, computer mouse, microphone, and so on). It is noted that the user input interface may be a user input interface of system 200, but an external user input interface may also be used.

Method 600, and especially stage 650, may optionally include other ways of modifying the BIM based on the results of the matching of stage 640. For example, method 600 may include any one or more of the following:
a. Generating new objects in the BIM based on location information of RTDM objects points (especially—of unmatched RTDM objects) of the RTDM.
b. Updating the location of BIM objects (e.g. walls, foundations etc.) in high accuracy, according to what was actually built on site.
c. Correcting dimensions of BIM objects (e.g. windows, cornices, etc.) in high accuracy, according to what was actually built.
d. Classifying of BIM objects according to RTDM information. It is noted that the classification may include classes which are more complex than just BIM data or just RTDM data, and may combine the two sources of information. For example, some classes may be “Existing exterior walls timely tiled with dimension stone”, “Existing pre-tiled exterior walls”, “Existing exterior walls whose tiling is behind schedule”, “exterior walls not yet built” and “Exterior walls erroneously tiled with incorrect materials”.

It is noted that method 600 may be implemented as instructions for a processor (e.g. a hardware and/or firmware processor of a computer), implemented on a non-transitory computer-readable medium. Any variation or implementation discussed above with respect to method 600 may also be implemented with respect to such a computer-readable medium, mutatis mutandis. Some examples to ways method 600 may be implemented using computer-readable code are provided below.

A non-transitory computer-readable medium for analyzing BIMs based on sensor-based RTDMs of buildings is disclosed, including instructions stored thereon, that when executed on a processor, perform the steps of:

Obtaining a BIM of a building, the BIM defining a plurality of multidimensional BIM objects associated with parts of the building, each BIM object having location information;

Obtaining an RTDM of the building which includes a plurality of RTDM objects, each having location information (the RTDM is reconstructed from information acquired by one or more optical sensors);

Aligning the RTDM and the BIM, thereby determining alignment information;

Matching to a selected BIM object at least one RTDM object, based on: (a) the alignment information, (b) the location information of the selected BIM object and (c) the location information of the at least one RTDM object; and

Determining supplementary information for the selected BIM object based on information of the at least one RTDM object matched to the selected BIM object.

Optionally, the RTDM may be a point cloud model.

Optionally, the one or more optical sensors are one or more airborne optical sensors.

Optionally, the one or more optical sensor includes one or more cameras which produce a plurality of images of the building captured at different camera locations.

Optionally, the non-transitory computer-readable medium may further include instructions stored thereon, that when executed on a processor, perform: generating the RTDM based on the information acquired by one or more optical sensors.

Optionally, the non-transitory computer-readable medium may further include instruction stored thereon, that when executed on a processor, perform: calculating distances between a RTDM object and BIM objects based on the alignment information, and matching for each RTDM object out of a plurality of RTDM objects a closest BIM object having a minimal distance to the respective RTDM object.

Optionally, the supplementary information includes a construction state for a part of the building associated in the BIM with the selected BIM object. Optionally, the non-transitory computer-readable medium may further include instructions stored thereon, that when executed on a processor, perform: obtaining a construction timing schedule for the part of the building, and determining a completion state for at least one predefined construction task based on a result of a comparison between the constructing timing schedule and the determined construction state.

Optionally, the non-transitory computer-readable medium may further include instructions stored thereon, that when executed on a processor, perform: determining a construction state for a part of the building based on at least two RTDMs generated from optical sensor information acquired at different days.

Optionally, the non-transitory computer-readable medium may further include instructions stored thereon, that when executed on a processor, perform: determining geometrical relationships between the selected BIM object and matching RTDM objects, and determining errors in the construction of a part of the building associated in the BIM with the selected BIM object.

Optionally, the non-transitory computer-readable medium may further include instructions stored thereon, that when executed on a processor, perform: modifying preexisting BIM information based on results of the matching.

Optionally, the non-transitory computer-readable medium may further include instructions stored thereon, that when executed on a processor, perform: generating new objects in the BIM based on the supplementary information.

Optionally, the non-transitory computer-readable medium may further include instructions stored thereon, that when executed on a processor, perform: superimposing at least a part of the RTDM and at least a part of the BIM based on a result of the matching, and obtaining a user input for a result of the superimposition. The supplementary information may be further based on the user input.

Optionally, the supplementary information includes color information associated by the RTDM with a RTDM object matched to the selected BIM object.

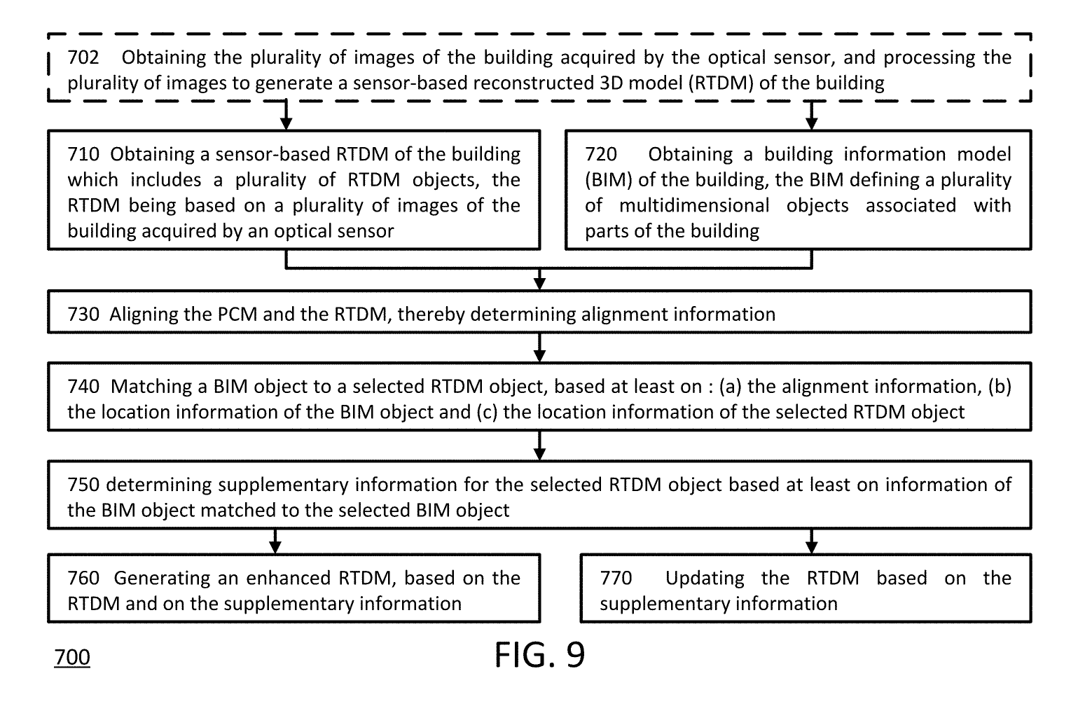

FIG. 9 is a flow chart illustrating an example of method 700, in accordance with the presently disclosed subject matter. Method 700 is a computer-implemented method for improved reconstructed three dimensional models (RTDMs) of buildings based on building information models (BIMs). Method 700 includes executing on a processor different steps, including at least stages 710, 720, 730, 740 and 750. Any other stage in the following description having a reference number starting with “7” (e.g. 750) may also be executed by the processor, or otherwise be part of method 700 (executed by a different unit). Referring to the examples set forth with respect to the following drawings, method 700 may be executed by system 200.

It is noted that method 700 may be implemented as a variation of method 500, and that the discussion above with any stage or sub-stage of method 500 (e.g. stages 510, 520, 530 and 540) may be applied, mutatis mutandis, to the respective stage of method 700 (e.g. stages 710, 720, 730 and 740, respectively)

Stage 710 includes obtaining a RTDM of the building which includes a plurality of RTDM objects, each having location information (the RTDM is reconstructed from information acquired by one or more optical sensors). Any information disclosed above with respect to stage 510 of method 500 is applicable, mutatis mutandis, to stage 710.

Stage 720 includes obtaining a BIM of a building, the BIM defining a plurality of multidimensional BIM objects associated with parts of the building, each BIM object having location information. Any information disclosed above with respect to stage 520 of method 500 is applicable, mutatis mutandis, to stage 720.

Stage 730 of method 700 includes aligning the RTDM and the BIM, thereby determining alignment information. Any information disclosed above with respect to stage 530 of method 500 is applicable, mutatis mutandis, to stage 730.

Stage 740 of method 700 includes matching a BIM object to a selected RTDM object, based at least on: (a) the alignment information, (b) the location information of the BIM object and (c) the location information of the selected RTDM object. The matching may be further based on locations of other objects—whether BIM objects and/or RTDM objects. Any information disclosed above with respect to stage 540 of method 500 is applicable, mutatis mutandis, to stage 740. Stage 740 may be repeated for any number of BIM objects. Stage 740 may be repeated for any number of RTDM objects.

It is noted that in some instances, the resolution of the BIM may be higher (i.e. finer) than that of the RTDM. By way of example, the resolution of the RTDM may be 5 or 10 cm in some location (e.g. based on the distance and angle of imaging of that location), and the BIM may include data for two layers of a window: a glass pane, and a sliding blind pane, each having a thickness of 2 cm. In such cases, method 700 may optionally include determining to which of the multiple BIM objects the respective RTDM object should be matched. Different types of rules may be used for such selection, such as selecting the outer BIM object. Optionally, if the BIM contains inside layers, only BIM objects which belong to the outer layer (or layers, e.g. depending on transparency and/or permeability of outer layer) are selected.

Stage 750 of method 700 includes determining supplementary information for the selected RTDM object based at least on information of the BIM object matched to the selected BIM object.

Stage 750 may optionally be followed by optional stage 760 and/or by optional stage 770.

Optional stage 760 includes generating an enhanced RTDM, based on the RTDM obtained in stage 710 and on the supplementary information determined in stage 750. The generating of the enhanced RTDM may include generating and storing on a tangible non-transitory computer readable medium at least one new computer file not existing previously, which includes enhanced RTDM information which is based on the results of stage 750. Referring to the elements set forth with respect to the following drawings, stage 760 may be executed by processor 220 and/or RTDM processing module 240.

Optional stage 770 includes updating the RTDM obtained in stage 710 based on the supplementary information determined in stage 750. The updating of the RTDM may include writing RTDM information which is based on the results of stage 750 to at least one existing computer file which includes RTDM information of the RTDM of stage 710 and that is stored on a tangible non-transitory computer readable. Referring to the examples set forth with respect to the following drawings, stage 760 may be executed by processor 220 and/or RTDM processing module 240.

The supplementary information determined in stage 750 may include many types of information, such as (although not limited to):
a. Matching information for a RTDM object, identifying one or more BIM objects matched to that RTDM object in stage 740.
b. Location of one or more BIM objects matched to that RTDM object in stage 740.
c. Type of building part (e.g. wall, door, foundation) associated with the BIM object matched to that RTDM object in stage 740.
d. Other semantics associated with the BIM object matched to that RTDM object in stage 740.
e. And so on.

Additional types of supplementary information are suggested below, with respect to the following drawings.

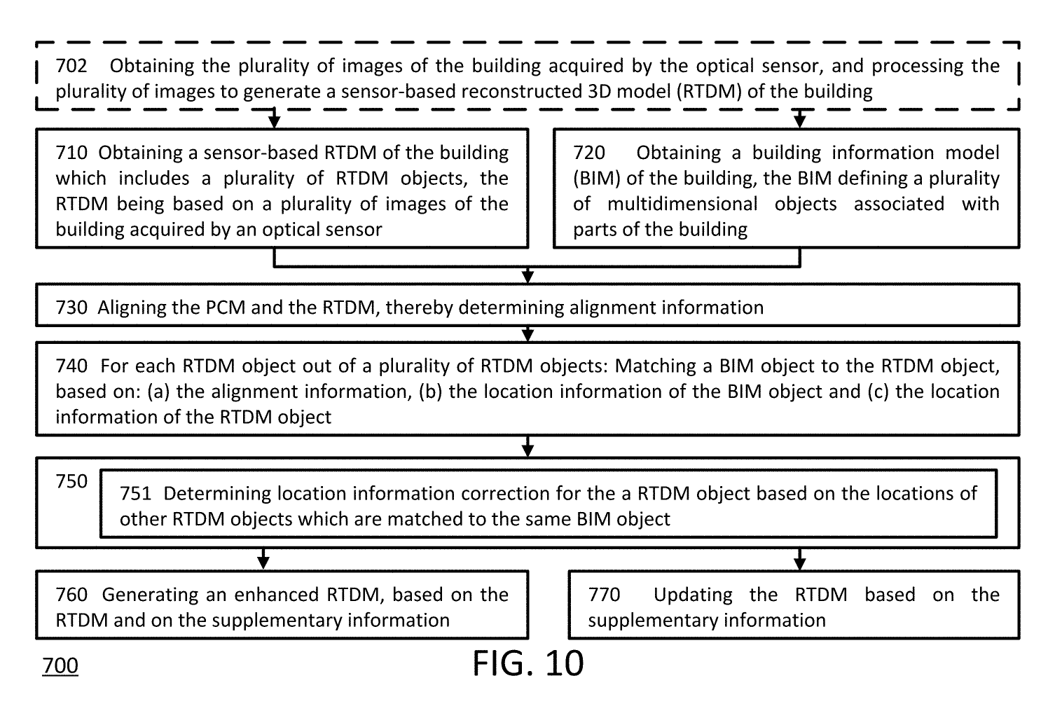

FIG. 10 is a flow chart illustrating an example of method 700, in accordance with the presently disclosed subject matter. As exemplified in FIG. 10, information from the BIM together with the matching of stage 740 may be used for correcting (e.g. increasing accuracy) of the RTDM. In the example of FIG. 10, stage 740 is executed for different RTDM objects. The matching of stage 740 in this examples results in a plurality of RTDM objects (e.g. PCM points of a point cloud) which are matched to the same BIM object. For example, a wall of a building is represented by a large BIM object, to which hundreds and thousands (and more) RTDM objects may be matched.

Stage 750 may include stage 751 of determining location information correction for the RTDM object based on the locations of other RTDM objects which are matched to the same BIM object. Generally, method 700 may include correcting a location of the selected RTDM object based on the locations of other RTDM objects which are matched to the same BIM object (e.g. as part of stage 760 and/or 770).

For example, if many PCM points (or other RTDM objects such as mesh polygons) are matched to a single BIM object (e.g. a planar window, a helical staircase, etc.), the location of some or all of those objects may be corrected based on supposed form information (e.g. plane, helix) derived from the BIM, e.g. using averaging of the RTDM locations of those RTDM objects. For example, if several points of the RTDM are matched to the same BIM object which is a wall, then these points may be corrected to appear on the same approximate surface. This may correct the typical larger error of photogrammetry-generated point clouds (or other types of RTDMs) in the direction vertical to surface (e.g. the aforementioned wall).

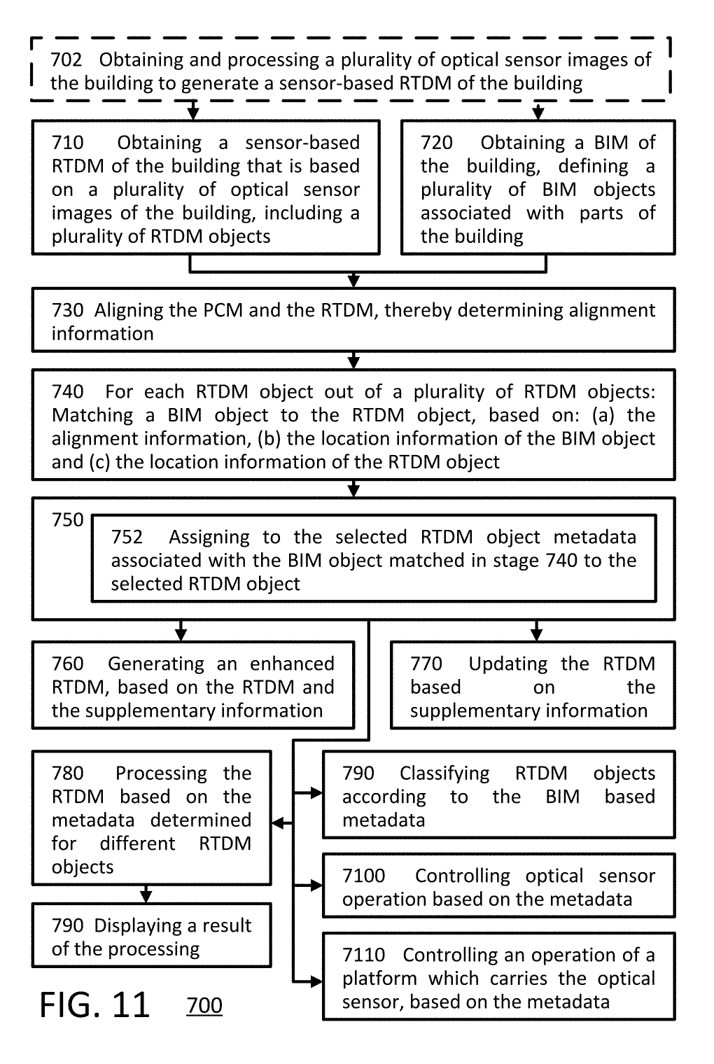

FIG. 11 is a flow chart illustrating an example of method 700, in accordance with the presently disclosed subject matter. As exemplified in FIG. 11, information from the BIM together with the matching of stage 740 may be used for assigning to RTDM objects metadata which is associated with BIM objects. As noted above, the BIM may include metadata for different BIM objects. Specifically, the BIM may include metadata for multidimensional objects to which RTDM are matched.

Such metadata may include, for example, metadata information of any one or more of the following metadata types:
a. Identification of construction element type.
b. Other characteristics of the construction element associated with the BIM object (e.g. material, color).
c. Business information relating to the construction element associated with the BIM object (e.g. cost, supplier, etc.).
d. Interconnection to other BIM elements or construction elements (e.g. building parts by which this element is supported).
e. Construction scheduling time (or demolition scheduling time).
f. Another timing information (e.g. technical inspection due dates).
g. Timing information related to other objects (e.g. the associated BIM object is planned to be constructed only after another BIM element is finished, or before another construction element is removed from the site).

Further to assigning the metadata to the various portions of the RTDM, the RTDM may be displayed in association with the assigned metadata. For example, the RTDM may be displayed in one or more colors that indicate, respectively, the one or more element types represented by the portions of the RTDM. For example, one group of RTDM points may be displayed in a first color that indicates a wall, while another group of RTDM points may be displayed in a second color that indicates a door. Alternatively or additionally, one or more labels (e.g., “window” or “door”), which indicate the element types, may be displayed over or adjacent to the relevant portions of the RTDM.

Optionally, stage 750 may include stage 752 of assigning to the selected RTDM object metadata associated with the BIM object matched in stage 740 to the selected RTDM object. The assigning of stage 752 may include assigning to the selected RTDM object any one or more of the metadata types indicated in the previous paragraph, and/or other types of metadata.

Stage 752 may be followed by several different uses, including but not limited to:
a. Stage 780 of processing the RTDM based on the metadata determined for different RTDM objects, which may be followed by stage 790 of displaying a result of the processing.
b. Stage 790 of a classifying RTDM objects according to the metadata. It is noted that the classification may include classes which are more complex than the metadata of the BIM, and may also be based on RTDM information. For example, some classes may be “Existing exterior walls already tiled with dimension stone”, “Existing pre-tiled exterior walls”.
c. Stage 7100 of controlling an operation of the optical sensor based on the metadata determined for the different RTDM objects. For example, this may include determining that an RTDM object was assigned BIM metadata indicating that the accuracy of location of the corresponding structure is very important, and hence, the RTDM object should be photographed in higher resolution.
d. Stage 7110 of controlling an operation of a platform (e.g. an aircraft, a ground vehicle, a crane) which carries the optical sensor, based on the metadata determined for the different RTDM objects. For example, this may include determining that an RTDM object was assigned BIM metadata indicating that the accuracy of location of the corresponding structure is very important, and hence, the RTDM object should be photographed from a closer distance and/or with a slower moving speed of the platform.

Referring to stage 780, the BIM based metadata assigned to different RTDM objects may be used, for example, for processing, analyzing, displaying or otherwise manipulating some or all of the objects of the RTDM (e.g. PCM points), whether as individual RTDM objects or as groups of RTDM objects collected by location, by metadata, or in any other way.

For example, optional stage 780 may include any combination of one or more of the following:

Selecting only RTDM objects which correspond to a subgroup of object types of the BIM, including one or more types. E.g. this may enable selection of only RTDM objects which correspond to the windows of the building, only to visible structural elements, only to temporary construction elements, and so on. The selected points may then be further processed, displayed, and so on.

It is noted that identifying that a plurality of RTDM objects are all matched to a single BIM object that is further characterized in the BIM (e.g. it is flat, it is circular, it is semitransparent, it is made of concrete, and so on) may enable to further amend and/or utilize the RTDM. For example, a plurality of RTDM objects which all belong to a single flat object (or to several objects which are flush to each other, perpendicular to each other, etc.) may enable to correct the locations of those RTDM objects in the RTDM, e.g. as discussed with respect to stages 750, 750 and 770 above.

Referring to stage 7100, the controlling performed during stage 7100 may be executed by a control unit integrated into the optical sensor, by a control unit integrated into or otherwise carried by a carrying platform (e.g. an aircraft, a crane) which carries the optical sensor, by a control unit located in the building or in its vicinity, by a remote server, by another control unit, or by any combination of the above. If the controlling is executed by a control unit (or control units) which is not the one which determined the metadata for the RTDM objects, data may be transferred to the respective control unit in any standard communication method known in the art (e.g. wired, wireless, internet, etc.).

The controlling of the optical sensor in stage 7100 may include, for example, any one or more of the following:
a. Selecting sensor parameters (e.g. aperture, exposure time, contrast, sensitivity, image resolution, etc.) for imaging certain types of points/objects/location, based on the metadata assigned to one or more RTDM objects.
b. Selecting acquisition angles for imaging certain types of points/objects/location, based on the metadata assigned to one or more points of the RTDM objects.

It is noted that methods 600 and/or 700 may also include controlling an operation of the optical sensor directly based on results on the matching (stages 650 and 750, respectively). This may include, for example, determining that RTDM objects whose matching was questionable should be photographed in higher resolution.

Referring to stage 7110, the controlling performed during stage 7110 may be executed by a control unit integrated into or otherwise carried by the carrying platform, by a control unit located in the building or in its vicinity, by a remote server, by another control unit, or by any combination of the above. If the controlling is executed by a control unit (or control units) which is not the one which determined the metadata for the RTDM objects, than data may be transferred to the respective control unit in any standard communication method known in the art (e.g. wired, wireless, internet, etc.).

The controlling of the operation of the platform in stage 7110 may include, for example, any one or more of the following:
a. Selecting flight (or movement) parameters (e.g. hover location, image acquisition locations, velocity, roll speed and angles, flight direction, altitude, and so on) for imaging certain types of points/objects/location, based on the metadata assigned to one or more RTDM objects.
b. Planning a flight path (or movement plan) for the platform based on the RTDM and the metadata assigned to some or all of the RTDM objects of the model.

It is noted that methods 600 and/or 700 may also include controlling an operation of the optical sensor directly based on results on the matching (stages 650 and 750, respectively). This may include, for example, determining that RTDM objects whose matching was questionable should be photographed in higher resolution.

It is noted that methods 600 and/or 700 may also include controlling an operation of the carrying platform directly based on results on the matching (stages 650 and 750, respectively). This may include, for example, determining that RTDM objects whose matching was questionable should be photographed from a closer distance.

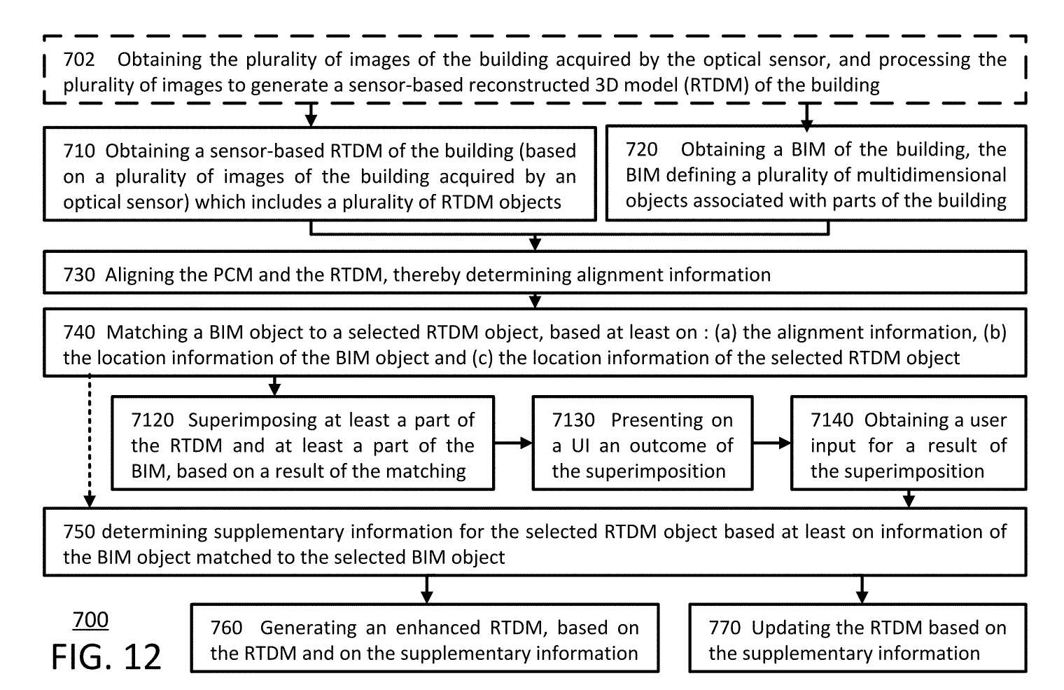

FIG. 12 is a flow chart illustrating an example of method 700, in accordance with the presently disclosed subject matter. Optionally, method 700 may include stage 7120 of superimposing at least a part of the RTDM and at least a part of the BIM (i.e., superimposing at least a part of the RTDM onto at least a part of the BIM, or vice versa), based on a result of the matching. Referring to the examples set forth with respect to the previous drawings, stage 7120 may be executed by processor 220 or by any other processing module.

Method 700 may also include stage 7130 of presenting on a user interface (UI) an outcome of the superimposition, and stage 7140 of obtaining a user input for a result of the superimposition. The supplementary information in such case may further be based on the user input. The user input may include manipulation by the user of BIM information (or her other reaction to BIM information), manipulation by the user of RTDM information (or her other reaction to RTDM information), manipulation by the user of combined BIM and RTDM information (or her other reaction to BIM and RTDM information), or any other input which pertains to the superimposed input (e.g., a superimposed image, a superimposed 3D representation, or superimposed virtual reality data) presented to her.

Referring to the examples set forth with respect to the following drawings, the UI may be a UI of system 200 (e.g. a monitor or projector); alternatively or additionally, an external UI may be used. The user input may be received via any user input interface known in the art (e.g., a touchscreen, keyboard, computer mouse, or microphone). The user input interface may be a user input interface of system 200; alternatively or additionally, an external user input interface may be used.

It is noted that method 700 may be implemented as instructions for a processor (e.g. a hardware and/or firmware processor of a computer), implemented on a non-transitory computer-readable medium. Any variation or implementation discussed above with respect to method 700 may also be implemented with respect to such a computer-readable medium, mutatis mutandis. Some examples of ways method 700 may be implemented using computer-readable code are provided below.

A non-transitory computer-readable medium for improved RTDMs of buildings based on BIMs is disclosed, including instructions stored thereon, that when executed on a processor, perform the steps of:

Obtaining a BIM of a building, the BIM defining a plurality of multidimensional BIM objects associated with parts of the building, each BIM object having location information;

Obtaining an RTDM of the building which includes a plurality of RTDM objects each having location information (the RTDM is based on information acquired by one or more optical sensors);

Aligning the RTDM model and the BIM, thereby determining alignment information;

Matching a BIM object to a selected RTDM object, based on: (a) the alignment information, (b) the location information of the selected RTDM object and (c) the location information of the BIM object; and

Determining supplementary information for the selected RTDM object based on information of the BIM object matched to the selected BIM object.

Optionally, the RTDM may be a point cloud model.

Optionally, the one or more optical sensors are one or more airborne optical sensors.

Optionally, the one or more optical sensors include one or more cameras which produce a plurality of images of the building captured at different camera locations.

Optionally, the non-transitory computer-readable medium further includes instructions stored thereon, that when executed on a processor, perform: generating the RTDM based on the information acquired by one or more optical sensors.

Optionally, the non-transitory computer-readable medium further includes instructions stored thereon, that when executed on a processor, perform: calculating distances between a RTDM object and BIM objects based on the alignment information, and matching for each RTDM object out of a plurality of RTDM objects a closest BIM object having a minimal distance to the respective RTDM object.

Optionally, the BIM includes metadata for different BIM objects, and the instructions for determining include instructions stored thereon, that when executed on a processor, perform: assigning to the selected RTDM object metadata associated with the BIM object matched to the selected RTDM object.

Optionally, the non-transitory computer-readable medium further includes instructions stored thereon, that when executed on a processor, perform: processing the RTDM based on the metadata determined for different RTDM objects, and displaying a result of the processing.

Optionally, the non-transitory computer-readable medium further includes instructions stored thereon, that when executed on a processor, perform: classifying objects in the RTDM according to the metadata.

Optionally, the non-transitory computer-readable medium further includes instructions stored thereon, that when executed on a processor, perform: controlling an operation of the optical sensor based on the metadata determined for the different RTDM objects.

Optionally, the non-transitory computer-readable medium further includes instructions stored thereon, that when executed on a processor, perform: controlling an operation of a platform which carries the optical sensor based on the metadata determined for the different RTDM objects.

Optionally, the non-transitory computer-readable medium further includes instructions stored thereon, that when executed on a processor, perform: after the determining, correcting a location of the selected RTDM object based on the locations of other RTDM objects which are matched to the same BIM object.

Optionally, the non-transitory computer-readable medium further includes instructions stored thereon, that when executed on a processor, perform: superimposing at least a part of the RTDM and at least a part of the BIM based on a result of the matching, and obtaining a user input for a result of the superimposition. The supplementary information may further be based on the user input.

FIGS. 4 through 12 where used to discuss several optional ways in which the matching of stage 540 can be used. It is noted that any combination of the optional stages detailed in those drawings (i.e. stages 650, 660, 660, 670, 680, 690, 6100, 650, 760, 760, 770, 780, 790, 7100, 7110, 7120, 7130, and 7140, as well as their sub-stages) may be implemented. For example, a single instance of stage 540 may be followed by generating an enhanced BIM (stage 660), correction of the RTDM (stage 670) and determining a completion state for parts of the building (stage 6511).

It is noted that other methods are included within the scope of the present invention, these methods including any combination of one or more of the optional stages (i.e. stages 650, 660, 660, 670, 680, 690, 6100, 650, 760, 760, 770, 780, 790, 7100, 7110, 7120, 7130, and 7140, as well as their sub-stages) and optionally also some combination of one or more of stages 510, 520, 530 and/or 540. Accordingly, it is noted that the alignment of stage 530 and/or the matching of stage 540 may be executed by one machine, system or entity, while the following processes may be executed by another machine, system or entity. The actions of that optional other machine are also independently claimed as part of the invention.

It is noted that any of those methods (including any combination of one or more of the optional stages (i.e. stages 650, 660, 660, 670, 680, 690, 6100, 650, 760, 760, 770, 780, 790, 7100, 7110, 7120, 7130, and 7140, as well as their sub-stages) and optionally also some combination of one or more of stages 510, 520, 530 and/or 540) may be implemented as instructions for a processor (e.g. a hardware and/or firmware processor of a computer), implemented on a non-transitory computer-readable medium.

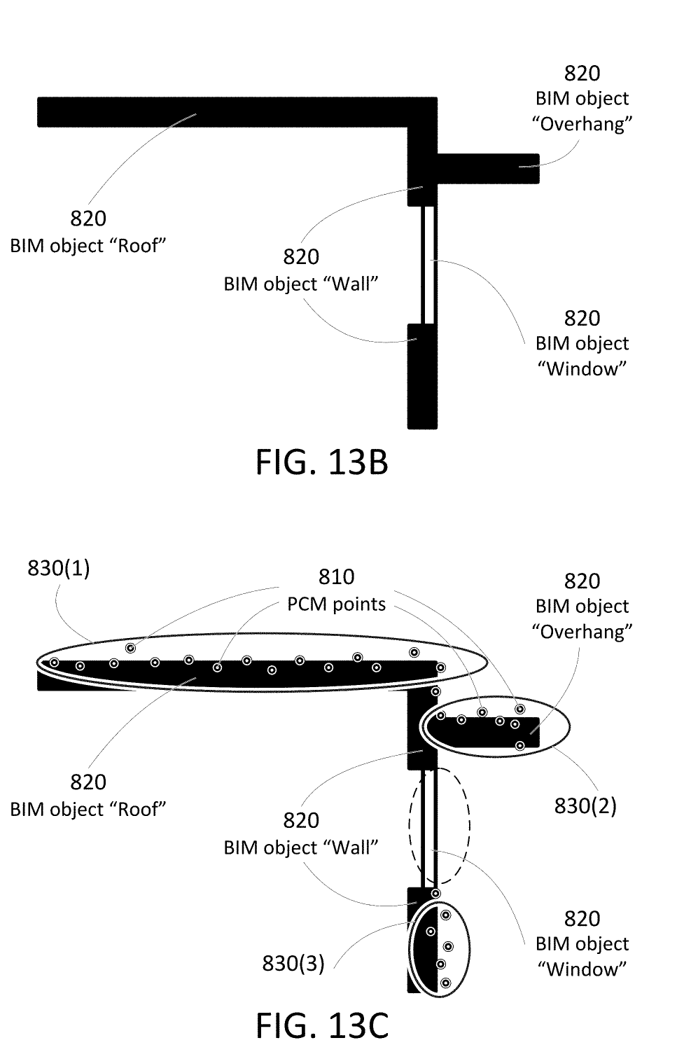

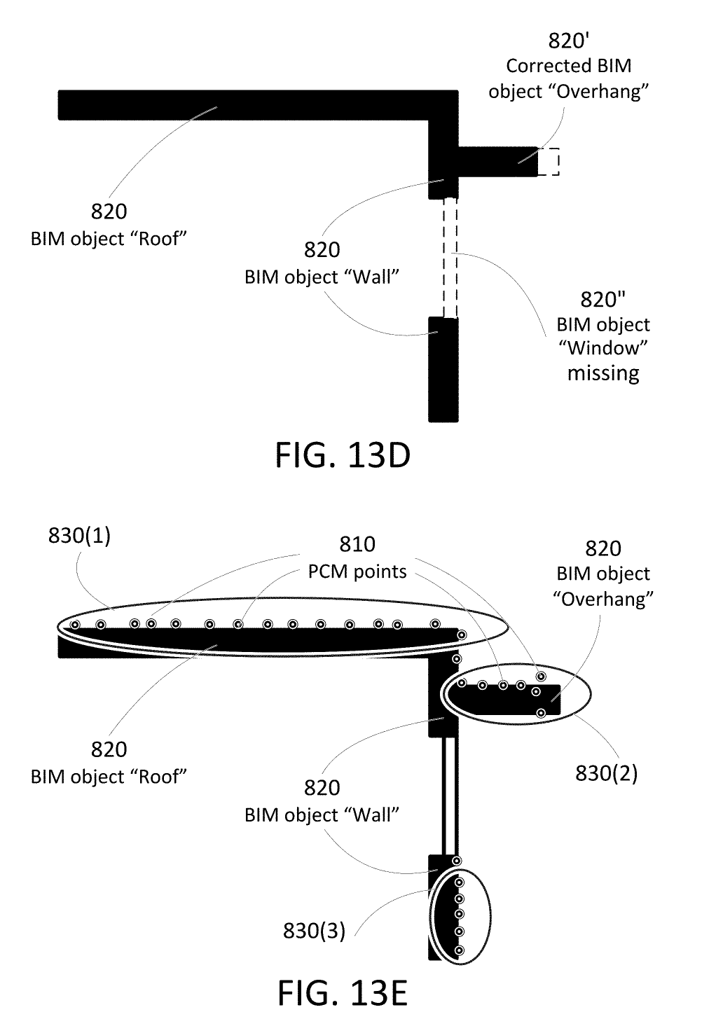

FIGS. 13A through 13E are diagrams illustrating the matching of RTDM objects to multidimensional BIM objects, in accordance with examples of the presently disclosed subject matter. The matching represented is an example of stage 530 of method 500, stage 630 of method 600, and stage 730 of method 700.

For the sake of simplicity of the illustration, the RTDM type illustrated is a point cloud model (PCM), and its objects are points of the point cloud (referred to as PCM points). It is nevertheless noted that every discussion with respect to FIGS. 13A through 13E which pertains to PCM and/or PCM points is likewise applicable, mutatis mutandis, to other types of RTDM and RTDM objects, e.g., to polygon meshes whose objects are polygons (possibly including additional data such as texture).

The density (number of points per unit of area) of PCM points in the illustrations of those figures is very low and the errors in their locations are very exaggerated, for the sake of clarity of illustration. All of FIGS. 13A through 13E represent the same cross-section of a part of a building, including an idealized roof, wall, window and overhang.

FIG. 13A illustrates a set of PCM points from the PCM of the building, derived from a plurality of areal images of the building, e.g. as discussed above, using any photogrammetry technique. FIG. 13B illustrates the portion of the BIM that, further to the registration between the BIM and the PCM, was matched to the set of PCM points in FIG. 13A.

FIG. 13C illustrates an overlay of the PCM points of FIG. 13A over the portion of the BIM of FIG. 13B. The overlay between those two models is achieved using the alignment information of stage 530 (corresponding to stages 630 and 730). As illustrated in an exaggerated form in FIG. 13C, in many points the overlay includes discrepancies between the two models, the PCM and the BIM.

The matching of PCM points 810 and BIM objects 820 in the present example includes matching the PCM points enclosed in ellipse 830(1) to the BIM object “Roof”, matching the PCM points enclosed in ellipse 830(2) to the BIM object “Overhang”, and matching the PCM points enclosed in ellipse 830(3) to the BIM object “Wall”. As can be seen, there are no PCM points near the geolocations of BIM object “window” (illustrated by a dashed ellipse), and possibly some of the PCM points and some of the BIM objects may be left unmatched.

Based on the registration of FIG. 13C, the BIM and/or the PCM may be modified. Typically, for large discrepancies, the BIM is modified. For example, if one of the BIM elements is seen to be missing from the PCM, this element may be removed from the BIM. For example, FIG. 13D illustrates corrections made to the BIM, based on information derived from the PCM. In this example, the photogrammetry of the building and the matching of it to the BIM using method 500 allowed detection that the BIM object “overhang” is smaller in reality than it should be, and that the BIM object “window” is missing.

Conversely, for smaller discrepancies, the PCM is typically modified, since a small discrepancy generally indicates a problem with the construction of the PCM, rather than an actual discrepancy between the building plan and the current state of construction. For example, FIG. 13E illustrates corrections made to the PCM, based on information derived from the BIM. Since all the points of ellipse 830(1) correspond to the same BIM object (“Roof”) which is known to be flat, the geolocations of the points of the PCM are corrected, at least in the z-axis (x and y being the horizontal axes and z the vertical axis). Within ellipse 830(2) (corresponding to the “overhang” BIM object), the locations of only some of the PCM points are corrected—those which are clearly part of the top of the overhang, rather than the side of the overhang. As can be seen for the correction in locations of ellipse 830(1), the correction does not necessarily bring the points to a zero error in dislocation in any axis, but it may greatly reduce the overall error of the points. (In some implementations, it can reduce the error by a factor of \sqrt{N}, N being the number of points in the respective group.)

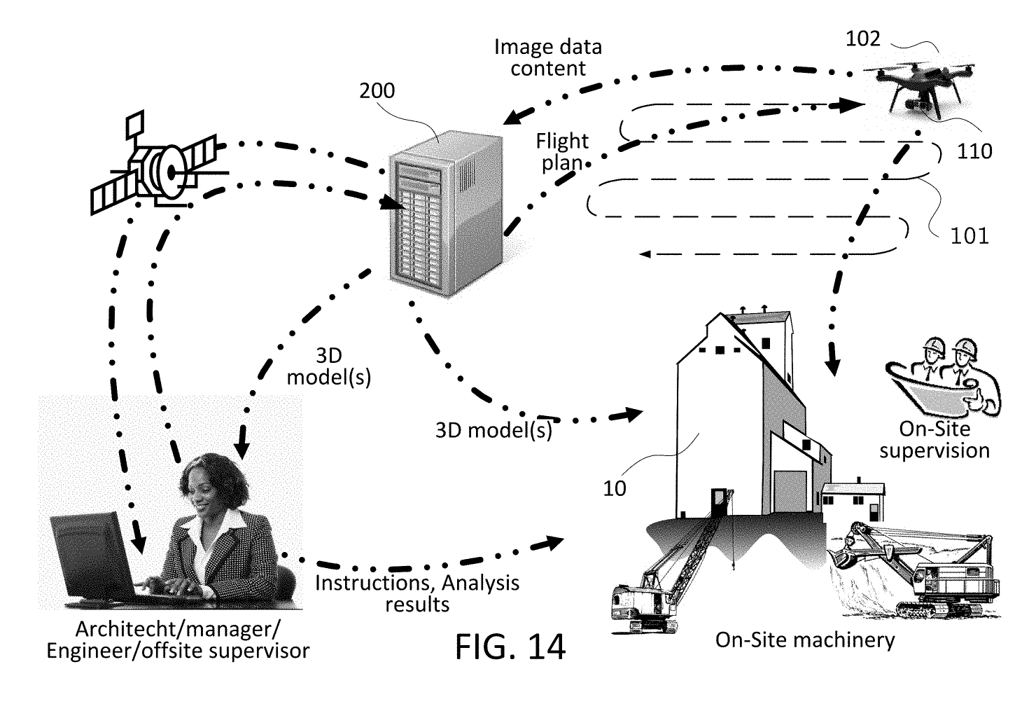

FIG. 14 illustrates an environment in which any one of methods 500, 600 and 700 could be executed and utilized, as well as system 200, in accordance with the presently disclosed subject matter.

FIG. 14 illustrates system 200, building 10, flight path 101, and a plurality of example entities to which image data, 3D models and data based on those sources may be communicated, in accordance with examples of the presently disclosed subject matter. As noted above, other types of vehicles or platforms may also be used for moving optical sensor 110 (not illustrated). Alternatively (or in addition), several optical sensors (moving and/or unmoving) may be used.

For example, outputs of system 200 and/or methods 500, 600 and 700 (as well as information used by them) may be communicated by on-site supervisor, system and machinery, off-site supervisor, architect, engineer, and so forth. The data may be transmitted between those entities (including also system 200 and aircraft 102) by any communication infrastructure, including satellite communication, cable internet, radio transmission, cellular networks, and so on.

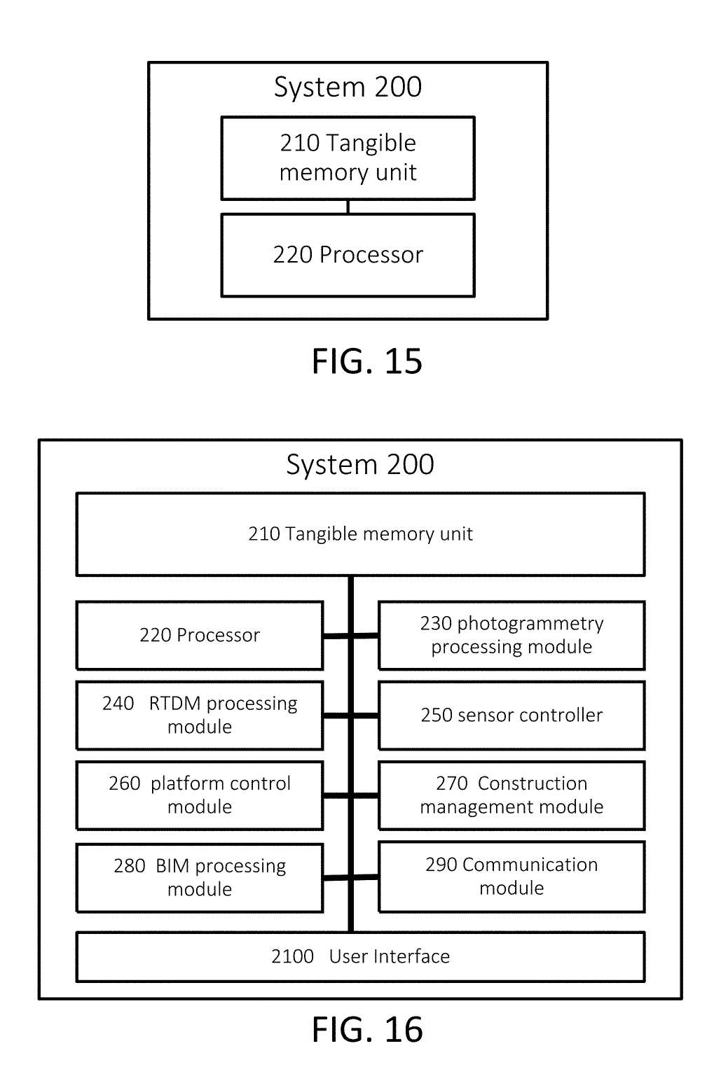

FIG. 15 is a functional block diagram illustrating an example of system 200 for model assisted building, in accordance with the presently disclosed subject matter. System 200 includes at least a tangible memory unit 210 (interchangeably “memory 210”) and processor 220. Memory unit 210 and processor 220 may be connected to each other physically (e.g. via cable connection, being implemented on a single chip, etc.), but this is not necessarily so.

Referring to the elements set forth with respect to the previous drawings, different variations of system 200 are operable to execute any variation of methods 500, 600 and 700 discussed above, even if not discussed in details for reasons of brevity of disclosure. It is noted that at least one component of system 200 may be adapted to execute any stage of the stages of methods 500, 600, and 700, mutatis mutandis.

Tangible memory unit 210 is operable to store at least:
a BIM of a building, which defines a plurality of multidimensional BIM objects associated with parts of the building, each BIM object having location information; and
an RTDM of the building which includes a plurality of RTDM objects, each having location information (the RTDM is reconstructed from information acquired by one or more optical sensors).

By storing the BIM, memory 210 gives yield to a stored BIM. By storing the RTDM, memory 210 gives yield to a stored RTDM.

It is noted that optionally, memory 210 may store models (RTDM and/or BIM) that are part of a larger model—e.g. including only some of the layer or metadata, or pertaining only to a part of the space modeled by the larger model (e.g. just one building out of a BIM of a building complex). Like in method 500, the utilized BIM and the RTDM overlap, at least partly, in their real-world coverage (i.e. both pertain to a common 3D space in the world, e.g. the same building).

Processor 220 is connected to tangible memory unit 210, and is configured to at least:
a. Align the RTDM and the BIM, thereby determining alignment information.
b. Match at least one BIM object and at least one RTDM object, based on: (a) the alignment information, (b) the location information the BIM object (and possibly also of other BIM objects) and (c) the location information of the RTDM object (and possibly also of other RTDM objects).

Additionally, processor 220 (or another processor of system 200, such as RTDM processing module 240 or BIM processing module 280, shown in FIG. 16) is configured to determine supplementary information for the BIM object and/or for the RTDM object, based on information of the matched object of the other model (BIM or RTDM).

As mentioned above, any variation discussed above with respect to methods 500, 600 and 700 is also applicable to system 200, mutatis mutandis. Especially, any one or more of the following variations may be implemented for system 200:

The RTDM may be a point cloud model.

The one or more optical sensors may be one or more airborne optical sensors.

The one or more optical sensor may include one or more cameras which produce a plurality of images of the building captured at different camera locations.

The one or more optical sensor may include one or more LIDARs which produce a plurality of depth readings of various locations of the building, captured at different camera locations.

Processor 220 may be configured to calculate distances between an RTDM object and BIM objects based on the alignment information, and to match an RTDM object to a closest BIM object having a minimal distance to the RTDM object.

System 200 may comprise, for example, a dedicated server, a desktop computer, a portable computer, or combination of several computers. System 200 may implement, mutatis mutandis, any variation of the methods discussed above.

In general, processor 220 may be embodied as a single processor, or as a cooperatively networked or clustered set of processors. In some embodiments, processor 220 is implemented solely in hardware, e.g., using one or more Application-Specific Integrated Circuits (ASICs) or Field-Programmable Gate Arrays (FPGAs). In other embodiments, processor 220 is at least partly implemented in software. For example, each of the processors may be implemented as a programmed digital computing device comprising a central processing unit (CPU), random access memory (RAM), non-volatile secondary storage, such as a hard drive or CD ROM drive, network interfaces, and/or peripheral devices. Program code, including software programs, and/or data are loaded into the RAM for execution and processing by the CPU and results are generated for display, output, transmittal, or storage, as is known in the art. The program code and/or data may be downloaded to the processor in electronic form, over a network, for example, or it may, alternatively or additionally, be provided and/or stored on non-transitory tangible media, such as magnetic, optical, or electronic memory. Such program code and/or data, when provided to the processor, produce a machine or special-purpose computer, configured to perform the tasks described herein.

FIG. 16 illustrates additional optional components of system 200, in accordance with examples of the presently disclosed subject matter. It is noted that any combination of components illustrated in FIG. 16 may be implemented, and not necessarily all of them. It is also noted that the connections between components as exemplified in FIG. 16 (on a common bus) are merely examples, and other ways of connecting modules may be implemented, depending on the specific implementation of the system.

Optionally, system 200 may also include photogrammetry processing module 230, operable to process the plurality of images of the building acquired by the optical sensor, and to generate the RTDM model based on the plurality of images. The images may be stored on the same memory 210, or on another memory unit. Photogrammetry processing module 230 (along with the other modules shown in FIG. 16) may be implemented as a module of processor 220, as a module of another processor of system 200, or as an independent processor.

Optionally, processor 220 may be configured to match a BIM object to an RTDM object (e.g. a PCM point) by determining a closest BIM object out of the objects of the BIM, so that a distance between the location of the RTDM object to the location of the closest BIM object (after alignment of the models) is smaller than any distance between the location of the RTDM object to any location of any other BIM object of the BIM. Processor 220 may than match the closest object to the respective geolocation point.

Optionally, system 200 may be used for analyzing BIMs based on sensor based RTDMs of buildings, e.g. similarly to the discussion offered with respect to method 600.

In such a case, processor 220 is configured to match to a selected BIM object at least one RTDM object, based on: (a) the alignment information, (b) the location information of the selected BIM object and (c) the location information of the at least one RTDM object. In addition, system 200 includes BIM processing module 280 (which may be implemented as a module of processor 220, as a module of another processor of system 200, or as an independent processor), which is configured to determine supplementary information for the selected BIM object, based on information of the at least one RTDM object matched to the selected BIM object.

BIM processing module may be further configured to write the supplementary information determined for the selected BIM object to memory 210. The writing may include updating an existing BIM file, overwriting an existing BIM file, replacing an existing BIM file, and/or generating a new BIM file. The one or more files are written to and stored in memory 210.

Any supplementary information for BIM objects discussed with respect to method 500, 600 or 700 may be determined by BIM processing module 280. For example, the supplementary information may include a construction state for a part of the building associated in the BIM with the selected BIM object.

Optionally, the supplementary information may include color information associated by the RTDM with an RTDM object matched to the selected BIM object.

Optionally, system 200 may include construction management module 270 (which may be implemented as a module of processor 220, as a module of another processor of system 200, or as an independent processor), which is a processor configured to:
a. Obtain a construction timing schedule for the part of the building.
b. Determine a completion state for at least one predefined construction task based on a result of a comparison between the constructing timing schedule and the determined construction state.

Optionally, construction management module 270 may be configured to determine a construction state for a part of the building based on at least two RTDMs generated from optical sensor information acquired at different days.

Optionally, system 200 may include a processor (processor 220, construction management module 270, or any other processor of system 200) which is configured to:
a. Determine geometrical relationships between the selected BIM object and matching RTDM objects, and
b. Determine errors in the construction of a part of the building associated in the BIM with the selected BIM object.

Optionally, system 200 may include a processor (processor 220, BIM processing module 280, or any other processor of system 200) which is configured to modify preexisting BIM information stored in the tangible memory unit, based on results of the matching.

The modifying may include, for example, reflecting an actual construction state (based on sensor data) in the BIM, in places where it does not match the planned BIM. For example, processing of the RTDM data and the BIM data by system 200 may reveal that a wall was built some 30 cm from its planned location, that a foundation shaft was drilled deeper (or shallower) than originally planned, and so on.

Optionally, system 200 may include a processor (processor 220, BIM processing module 280, or any other processor of system 200) which is configured to generate new objects in the BIM based on the supplementary information, and to write the new objects to the BIM stored in tangible memory unit 210.

Optionally, processor 220 may be configured to:
a. Superimpose at least a part of the RTDM onto at least a part of the BIM (or vice versa), based on a result of the matching between at least one RTDM object and at least one BIM object.
b. Obtain a user input for a result of the superimposition (e.g. via user interface 2100).
c. Determine at least a part of the supplementary information based on the user input.

Optionally, system 200 may be used for improved RTDMs of buildings based on BIMs, e.g. similarly to the discussion offered with respect to method 700. In such a case, processor 220 is configured to:
a. Match a BIM object to a selected RTDM object, based on: (a) the alignment information, (b) the location information of the selected RTDM object and (c) the location information of the BIM object.
b. Determine supplementary information for the selected RTDM object based on information of the BIM object matched to the selected BIM object.

Optionally, the BIM may include metadata for different BIM objects. System 200 may include RTDM processing module 240 (implemented as a module of processor 220, as a module of another processor or system 200, or as an independent processor). RTDM processing module 240 may be configured to assign to the selected RTDM object metadata associated with the BIM object matched to the selected RTDM object.

Optionally, RTDM processing module 240 may be configured to process the RTDM based on the metadata determined for different RTDM objects, and to display a result of the processing.

Optionally, RTDM processing module 240 may be configured to classify objects in the RTDM according to the metadata.

Optionally, system 200 may include sensor controller 250 configured to control an operation of the optical sensor (or one of the optical sensors which acquire the images used for the generation of the RTDM), based on the results of the matching of one or more RTDM objects to one or more BIM objects. For example, sensor controller 250 may be configured to control the operation of the optical sensor based on the metadata determined for the different RTDM objects.

Sensor controller 250 may be implemented as a module of processor 220, as a module of another processor of system 200, or as an independent processor. It is noted that the control of the optical sensor by sensor controller 250 may be direct (e.g., by transmitting direct camera instructions) or indirect (e.g., by preparing an image acquisition plan).

Optionally, system 200 may include platform control module 260, configured to control an operation of the platform which carries the optical sensor (or one of the optical sensors which acquire the images used for the generation of the RTDM), based on the results of the matching of one or more RTDM objects to one or more BIM objects. The platform may be, for example, a drone or another type of aircraft, a land vehicle, or a crane.

For example, platform control module 260 may be configured to control an operation of a platform which carries the optical sensor based on the metadata determined for the different RTDM objects.

Platform control module 260 may be implemented as a module of processor 220, as a module of another processor of system 200, or as an independent processor. It is noted that the control of the platform by platform control module 260 may be direct (e.g., by transmitting direct flight instructions) or indirect (e.g., by preparing a flight plan).

Optionally, RTDM processing module 240 may be configured to correct a location of the selected RTDM object based on the locations of other RTDM objects which are matched to the same BIM object.

Optionally, processor 220 may be configured to:
a. Superimpose at least a part of the RTDM onto at least a part of the BIM (or vice versa) based on a result of the matching.
b. Obtain a user input for a result of the superimposition (e.g., via user interface 2100).
c. Determine the supplementary information further based on the user input.

System 200 may include additional modules, such as communications module 290 (e.g., for communicating with the aircraft or with the sensor, and/or for transmitting information to and/or receiving information from other entities, such as those discussed with respect to FIG. 10) and user interface 2100.

The discussion above pertaining to system 200 discloses several optional ways in which the matching of BIM objects and RTDM objects may be used by system 200. It is noted that any combination of those ways may be implemented. For example, system 200 may be configured to generate an enhanced BIM, correct the RTDM, and determine a completion state for parts of the building, based on a single registration between the BIM and RTDM.

It is noted that other systems are included within the scope of the present invention, in which the processor does not perform the alignment, but rather receives the alignment information from another processor, system or service. Such a system may implement any one or more of the alignment techniques disclosed with respect to system 200, and is also included within the scope of the present invention.

The invention may also be implemented in a computer program for running on a computer system, at least including code portions for performing steps of a method according to the invention when run on a programmable apparatus, such as a computer system, or enabling a programmable apparatus to perform functions of a device or system according to the invention. The invention may also be implemented in a computer program for running on a computer system, at least including code portions that make a computer execute the steps of a method according to the invention.

A computer program is a list of instructions such as a particular application program and/or an operating system. The computer program may for instance include one or more of: a subroutine, a function, a procedure, a method, an implementation, an executable application, an applet, a servlet, source code, code, a shared library/dynamic load library and/or other sequence of instructions designed for execution on a computer system.

The computer program may be stored internally on a non-transitory computer readable medium. All or some of the computer program may be provided on computer readable media permanently, removably or remotely connected to an information processing system. The computer readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

It will be appreciated by persons skilled in the art that the present invention is not limited to what has been particularly shown and described hereinabove. Rather, the scope of embodiments of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a memory; and
a processor, configured to:
obtain, from the memory, a first digital building information model (BIM) that models a building plan for a building by virtue of defining a plurality of BIM objects associated with respective planned portions of the building, each BIM object having location information that indicates a respective location of the planned portion of the building that is associated with the BIM object,
obtain a reconstructed three dimensional model (RTDM) of the building that was reconstructed from information acquired by one or more optical sensors,
using the location information of one or more of the BIM objects, identify a correspondence between a portion of the RTDM and at least one of the BIM objects, by registering the RTDM and the first BIM to one another,
identify a difference between the portion of the RTDM and the corresponding BIM object, and
generate a second digital BIM that models a current construction state of the building, by modifying the first BIM to account for the identified difference.

2. The system according to claim 1, wherein the RTDM includes a point cloud model.

3. The system according to claim 1, wherein the one or more optical sensors include one or more airborne optical sensors.

4. The system according to claim 1, wherein the processor is configured to obtain the RTDM by generating the RTDM from the information acquired by the one or more optical sensors.

5. The system according to claim 1, wherein the processor is configured to identify the difference by identifying geometrical relationships between the portion of the RTDM and the corresponding BIM object.

6. The system according to claim 1, wherein the processor is configured to, in identifying the difference, identify an error in construction of the planned portion of the building that is associated with the corresponding BIM object.

7. The system according to claim 1, wherein the processor is configured to modify the first BIM to account for the identified difference by adding at least one new BIM object to the first BIM.

8. The system according to claim 1, wherein the processor is configured to modify the first BIM to account for the identified difference by removing at least one of the BIM objects from the first BIM.

9. The system according to claim 1, wherein the processor is configured to modify the first BIM to account for the identified difference by adding color information, which is associated with the portion of the RTDM, to the first BIM.

10. A system, comprising:
a memory; and
a processor, configured to:
obtain, from the memory, a digital building information model (BIM) that models a building plan for a building by virtue of defining a plurality of BIM objects associated with respective planned portions of the building, each BIM object having location information that indicates a respective location of the planned portion of the building associated with the BIM object,
obtain a reconstructed three dimensional model (RTDM) of the building that was reconstructed from information acquired by one or more optical sensors,
using the location information of one or more of the BIM objects, identify a correspondence between a portion of the RTDM and at least one of the BIM objects, by registering the RTDM and the BIM to one another, and
modify the portion of the RTDM, based on the corresponding BIM object.

11. The system according to claim 10, wherein the processor is configured to modify the portion of the RTDM by assigning, to the portion of the RTDM, metadata associated with the corresponding BIM object.

12. The system according to claim 11, wherein the processor is further configured to display the portion of the RTDM in association with the assigned metadata.

13. The system according to claim 11, wherein the metadata include a type of the planned portion of the building that is associated with the corresponding BIM object.

14. The system according to claim 11, wherein the processor is further configured to control an operation of at least one of the optical sensors, based on the metadata.

15. The system according to claim 10, wherein the processor is configured to modify the portion of the RTDM by correcting a location of an object belonging to the portion of the RTDM.

16. A method, comprising:
using a processor, obtaining a first digital building information model (BIM) that models a building plan for a building by virtue of defining a plurality of BIM objects associated with respective planned portions of the building, each BIM object having location information that indicates a respective location of the planned portion of the building that is associated with the BIM object;
obtaining a reconstructed three dimensional model (RTDM) of the building that was reconstructed from information acquired by one or more optical sensors;
using the location information of one or more of the BIM objects, identifying a correspondence between a portion of the RTDM and at least one of the BIM objects, by registering the RTDM and the first BIM to one another;
identifying a difference between the portion of the RTDM and the corresponding BIM object; and
generating a second digital BIM that models a current construction state of the building, by modifying the first BIM to account for the identified difference.

17. The method according to claim 16, wherein the RTDM includes a point cloud model.

18. The method according to claim 16, wherein the one or more optical sensors include one or more airborne optical sensors.

19. The method according to claim 16, wherein obtaining the RTDM comprises obtaining the RTDM by generating the RTDM from the information acquired by the one or more optical sensors.

20. The method according to claim 16, wherein identifying the difference comprises identifying the difference by identifying geometrical relationships between the portion of the RTDM and the corresponding BIM object.

21. The method according to claim 16, wherein identifying the difference comprises identifying an error in construction of the planned portion of the building that is associated with the corresponding BIM object.

22. The method according to claim 16, wherein modifying the first BIM to account for the identified difference comprises adding at least one new BIM object to the first BIM.

23. The method according to claim 16, wherein modifying the first BIM to account for the identified difference comprises removing at least one of the BIM objects from the first BIM.

24. The method according to claim 16, wherein modifying the first BIM to account for the identified difference comprises adding color information, which is associated with the portion of the RTDM, to the first BIM.

25. A method, comprising:
using a processor, obtaining a digital building information model (BIM) that models a building plan for a building by virtue of defining a plurality of BIM objects associated with respective planned portions of the building, each BIM object having location information that indicates a respective location of the planned portion of the building associated with the BIM object;
obtaining a reconstructed three dimensional model (RTDM) of the building that was reconstructed from information acquired by one or more optical sensors;
using the location information of one or more of the BIM objects, identifying a correspondence between a portion of the RTDM and at least one of the BIM objects, by registering the RTDM and the BIM to one another; and
modifying the portion of the RTDM, based on the corresponding BIM object.

26. The method according to claim 25, wherein modifying the portion of the RTDM comprises modifying the portion of the RTDM by assigning, to the portion of the RTDM, metadata associated with the corresponding BIM object.

27. The method according to claim 26, further comprising displaying the portion of the RTDM in association with the assigned metadata.

28. The method according to claim 26, wherein the metadata include a type of the planned portion of the building that is associated with the corresponding BIM object.

29. The method according to claim 26, further comprising controlling an operation of at least one of the optical sensors, based on the metadata.

30. The method according to claim 25, wherein modifying the portion of the RTDM comprises modifying the portion of the RTDM by correcting a location of an object belonging to the portion of the RTDM.
